(19) United States
(12) Patent Application Publication
(10) Pub. No.: US 2018/0214827 A1
(43) Pub. Date: Aug. 2, 2018

(54) PERYLENE DIIMIDE BASED MEMBRANE AND METHODS OF USE THEREOF

(71) Applicant: YEDA RESEARCH AND DEVELOPMENT CO. LTD., Rehovot (IL)

(72) Inventors: Boris RYBTCHINSKI, Givaataim (IL); Erez COHEN, Rehovot (IL); Haim WEISSMAN, Rehovot (IL)

(73) Assignee: YEDA RESEARCH AND DEVELOPMENT CO. LTD., Rehovot (IL)

(21) Appl. No.: 15/742,541

(22) PCT Filed: Jul. 7, 2016
(86) PCT No.: PCT/IL2016/050726

§ 371 Date: Jan. 8, 2018

Related U.S. Application Data
(60) Provisional application No. 62/190,306, filed on Jul. 9, 2015.

(51) Int. Cl. B01D 71/64; B01D 71/36; B01D 71/66; C08G 73/10; C08L 79/08; B01D 69/12

(52) U.S. Cl. CPC B01D 71/64; B01D 71/36; B01D 71/66; C08G 73/10; B01D 65/02; B01D 69/12; B01D 2321/168; B01D 2313/24; C08L 79/08

(57) ABSTRACT

This invention is directed to filtration system, filtration apparatus and methods of use thereof, wherein the filtration system comprises a solid support, perylene diimide based membrane layer and a polymer, specifically a Nafion polymer. The system and apparatus of this invention enables filtration of solutes such as: dyes, salts, heavy metal ions, pharmaceuticals and small organic molecules.

### FIELD OF THE INVENTION

This invention is directed to filtration system, filtration apparatus and methods of use thereof, where in the filtration system comprises a solid support, perylene diimide based membrane layer and a polymer layer, specifically a Nafion polymer. The system and apparatus of this invention enables filtration of solutes such as: dyes, salts, heavy metal ions, pharmaceuticals and small organic molecules.

### BACKGROUND OF THE INVENTION

Separation and purification of water, organic molecules, pharmaceuticals, heavy metal ions, salts, dyes, nanoparticles (NPs) or biomolecules become increasingly important both for fundamental studies and applications.

Especially important are heavy metal ions which are present in waste water produced by numerous industrial processes, including fertilizers, metal plating, batteries, semiconductor and pesticides industries. These heavily toxic metals, such as Hg, Pb, Cd, Co, Ni and Cr aren't biodegradable and therefore accumulate in living organisms and plants where they cause negative health effects, for instance carcinogenic ones. Since heavy metals in many cases are disposed into the environment, particularly in developing countries, waste water treatment turn more and more significant. Among the common methods nowadays we can find carbon adsorption, precipitation, membrane filtration, co-precipitation/adsorption and ion exchange which is the most widely held method today.

Other known separation techniques include size exclusion chromatography, size-selective precipitation, gel electrophoresis and (ultra)centrifugation. Although these techniques can be used to separate according to size they are usually time or energy consuming. An emerging alternative to these methods is represented by filtration techniques. In particular, ultrafiltration is a pressure-driven separation process in which porous membranes retain particles larger than the membrane cut-off (ranging from 2 to 100 nm). Membrane processes allow fast separation, the use of small solvent volumes, and are suitable for separation and purification of various NPs. Filtration can be easily scaled up, allowing separation and purification on the industrial scale. All commercially available filtration membranes used today are either polymer-based or ceramic. Supramolecular structures have been used as templates for porous membranes and for modification of membrane pores.

Self-assembled perylene diimide based membranes are known as presented in International Publication WO 2012/025928.

Nafion, a perfluorosulfonic acid produced by Du Pont Co, is a widespread ionomer used mainly as a proton exchange membrane (PEM) in fuel cells. This solid polymer electrolyte is prepared by copolymerization of tetrafluoroethylene and perfluorovinyl ether with sulfonyl fluoride as its terminus. Hydrolysis of the latter forms the final product of perfluorosulfonic acid. Membranes comprised of Nafion have exceptional properties regarding solubility, ionic conductivity and stability and are therefore widely used in applications such as fuel cells and embedment of metal complexes for catalysis and photosensitization. The hydrophilic domains that contain sulfonic acid groups can adsorb water while the hydrophobic domains of perfluoro ether and tetrafluoroethylene are surrounding them, causing swelling of the hydrophilic areas and facilitating the desired proton transfer combined with water diffusion.

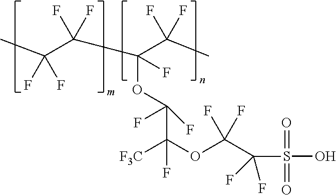

The challenge in creating filtration membranes relates to the robustness and the structure that is adequate for filtration, requiring a uniform porous array that maintains its integrity and pore sizes under the forces created by percolation of solvents and solutes during the filtration process.

### SUMMARY OF THE INVENTION

In one embodiment, this invention is directed to a filtration system comprising a solid support, a perylene diimide based membrane layer and a polymer layer. In another embodiment the perylene diimide based membrane is situated between the solid support and the polymer layer. In another embodiment, the peylene diimide based membrane layer is situated on said solid support and said polymer layer is situated on said perylene diimide based membrane layer.

In one embodiment, this invention is directed to a method of separation or filtration of materials, or purification of aqueous solutions comprising said materials, comprising transferring an aqueous solution or emulsion of said materials through said filtration system of this invention under pressure, wherein the particles which are larger than the pores of said filtration system remain on said polymer layer. In another embodiment, the materials for filtration comprise nanoparticles, heavy metal ions, salts, dyes, small organic molecules, pharmaceuticals. In another embodiment, the perylene diimide based membrane layer is recycled.

In one embodiment, this invention is directed to a filtration apparatus comprising:
a filtration system comprising a solid support, a perylene diimide (PDI) based membrane layer comprising perylene diimide (PDI) based compound and a polymer layer; wherein the PDI based membrane layer is located between the solid support and the polymer layer;
a first reservoir for filtration solution;
a first reservoir inlet (filtration inlet);
a first reservoir outlet;
a second reservoir for washing solution;
a second reservoir inlet (washing inlet);
a second reservoir outlet;
a connection between said second reservoir outlet and said first reservoir inlet, wherein said connection has an open or a closed position;
a pressure element, said element is connected to a selector, adapted to connect the pressure inducing element with said first reservoir inlet, or with said washing inlet, or to disconnect said pressure element from said reservoirs; and
an outlet from said filtration system;
   wherein,
at a first apparatus configuration, adapted for filtration, said first reservoir outlet is connected to said filtration system and said connection between said first reservoir inlet and second reservoir outlet is closed;
at a second apparatus configuration, adapted for washing, said first reservoir outlet is attached to said filtration system and said connection between said first reservoir inlet and second reservoir outlet is open such that said washing solution can be transferred from said second reservoir to said first reservoir;
and wherein said selector connects the pressure inducing element with said first reservoir inlet at said first configuration, and said selector connects the pressure inducing element with said second reservoir inlet at said second apparatus configuration.

In one embodiment, this invention is directed to a method of separation or filtration of materials, or purification of aqueous solutions comprising said materials, comprising the steps of:
transferring an aqueous solution or emulsion of said materials through a first reservoir inlet of a filtration apparatus, wherein said apparatus comprises:
   a filtration system comprising a solid support, a perylene diimide (PDI) based membrane layer comprising perylene diimide (PDI) based compound and a polymer layer; wherein the PDI based membrane layer is located between the solid support and the polymer layer;
   a first reservoir for filtration solution;
   a first reservoir inlet (filtration inlet);
   a first reservoir outlet;
   a second reservoir for washing solution;
   a second reservoir inlet (washing inlet);
   a second reservoir outlet;
   a connection between said second reservoir outlet and said first reservoir inlet, wherein said connection has an open or a closed position;
   a pressure inducing element, said element is connected to a selector, adapted to connect the pressure inducing element with said first reservoir inlet, or with said washing inlet, or to disconnect said pressure element from said reservoirs;
   an outlet from said filtration system;
wherein,
at a first apparatus configuration, adapted for filtration, said first reservoir outlet is connected to said filtration system and said connection between said first reservoir inlet and second reservoir outlet is closed;
at a second apparatus configuration, adapted for washing, said first reservoir outlet is connected to said filtration system and said connection between said first reservoir inlet and second reservoir outlet is open such that said washing solution can be transferred from said second reservoir to said first reservoir;
and wherein said selector connects the pressure inducing element with said first reservoir inlet at said first configuration, and said selector connects the pressure inducing element with said second reservoir inlet at said second apparatus configuration;
   adapting a first apparatus configuration for filtration,
   applying pressure such that said aqueous solution or emulsion is filtered via the filtration system and particles which are larger than the pores of said filtration system remain within said polymer layer or within said perylene diimide based membrane layer; and
   adapting a second apparatus configuration for washing,
   applying pressure such that the washing solution is transferred via the filtration system.

In another embodiment, the perylene diimide based membrane layer of this invention comprises one or more perylene diimide compounds, wherein each of said perylene diimide compounds is represented by the structure of formula I:

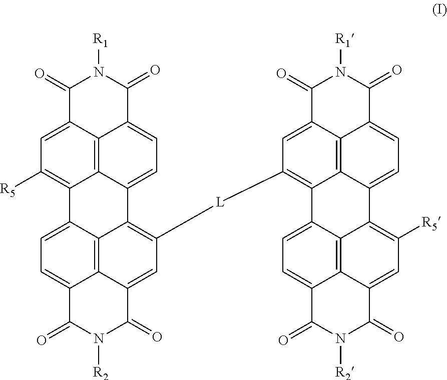

wherein

R₁ and R₁′ are each independently [(CH₂)_{q}O]ᵣCH₃, [(CH₂)_{q}O]ᵣH[(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₃NH]ₚH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₅)alkyl or (C₁-C₅)alkyl; and wherein R₃ in said [C(O)CHR₃NH]ₚH is an alkyl, haloalkyl, hydroxyalkyl, hydroxyl, aryl, phenyl, alkylphenyl, alkylamino and independently the same or different when p is larger than 1;

R₂ and R₂′ are each independently [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₄NH]ₛH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₅)alkyl or (C₁-C₅)alkyl; and wherein R₄ in said [C(O)CHR₄NH]ₛH is an alkyl, haloalkyl, hydroxyalkyl, hydroxyl, aryl, phenyl, alkylphenyl, alkylamino and independently the same or different when s is larger than 1;

R₅ and R₅′ are each independently H, —ORₓ where Rₓ is C₁-C₆ alkyl, [(CH₂)ₙO]ₒCH₃ or [(CH₂)ₙO]ₒH; [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)NH]ₒCH₃, [(alkylene)O]ₒCH₃, [(alkylene)C(O)O]ₒCH₃, [(alkylene)C(O)NH]ₒCH₃, [(alkylene)ₙCH₂═CH₂]ₒCH₃, [(alkylene)ₙCH≡CH]ₒCH₃, [(alkylene)ₙNH]ₒCH₃, aryl, heteroaryl, C≡C—R₇, CH═CR₈R₉, NR₁₀R₁₁, chiral group, amino acid, peptide or a saturated carbocyclic or heterocyclic ring wherein said saturated heterocyclic ring or heteroaryl contains at least one nitrogen atom and R₅ or R₅′ are connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);

R₇ is H, halo, (C₁-C₃₂)alkyl, aryl, NH₂, alkyl-amino, COOH, C(O)H, alkyl-COOH heteroaryl, Si(H)₃ or Si[(C₁-C₅)alkyl]₃ wherein said aryl or heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);

R₈, R₉, R₁₀ and R₁₁ are each independently H, (C₁-C₃₂)alkyl, aryl, NH₂, alkyl-amino, COOH, C(O)H, alkyl-COOH or heteroaryl wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);

L is a linker;

n is an integer from 1-5;

o is an integer from 1-100;

p is an integer from 1-100;

q is an integer from 1-5;

r is an integer from 1-100; and

s is an integer from 1-100;

wherein if R₅ and/or R₅′ are chiral; said membrane will form a chiral membrane.

In another embodiment, the perylene diimide based membrane layer of this invention comprises one or more perylene diimide compounds, wherein each of said perylene diimide compounds is represented by the structure of formula II:

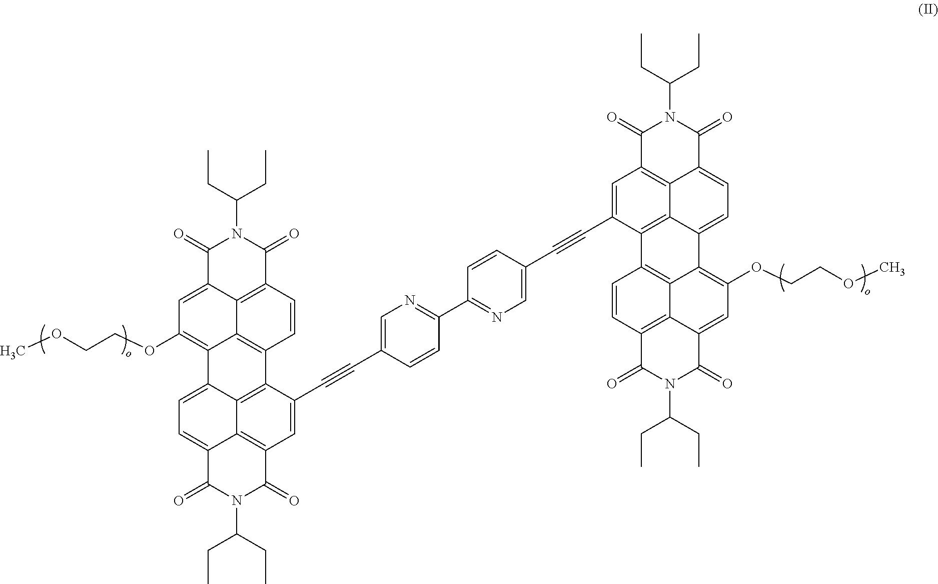

wherein o is an integer between 1 to 100.

In another embodiment, the perylene diimide based membrane layer comprises self-assembled of 2 to 10 perylene diimide compounds of formula II, each has a different integer “o”.

In one embodiment, this invention provides a filtration system comprising a solid support with pores size less than 10 nm and a Nafion layer, wherein the Nafion layer is situated on top of said solid support.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 presents the filtration apparatus of this invention. Reservoir A includes a washing solution (water) and Reservoir B includes a filtration solution and filtration system. On the right side, reservoir A is disconnected from Reservoir B and the filtration solution can be filtered via the filtration system (101) under pressure such as the argon gas pressure. On the left side, Reservoir A is connected to Reservoir B and a washing solution is transferred through Reservoir B to clean the filtration system that can be reused. The washing solution is connected to the argon gas to apply pressure for transferring the washing solution via Reservoir B and the filtration system.

FIGS. 2A and 2B present Cryo-SEM images of freshly prepared mixture of 5% PDI of formula II wherein o is 13 (PEG 13) with 95% PDI of formula II wherein o is 17 (PEG 17) supramolecular membrane cross section (˜1×1 mm) deposited on the PES support with Nafion (FIG. 2A) and without Nafion (FIG. 2B).

FIG. 3 presents distribution map and relative intensities of the elements in the membrane cross section, F atoms are marked in dark green (Al from the cross section stab).

FIG. 4 presents EDS X-ray spectrum of the highlighted area, the top layer of the membrane contains the F atoms from Nafion.

FIG. 5 presents filtration results of BromoCresol Green and checked the membrane performance in two states: anionic form in neutral water and neutral form in acidic water. After filtration both forms (anionic and neutral) are absent in the filtrate according to UV-vis spectroscopy. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 6 presents filtration results of Rhodamine 110. Top: Filtration of cationic and neutral forms of Rhodamine which are absent in the filtrate according to UV-vis spectroscopy. Bottom: Filtration of Rhodamine 110 at 5×10⁻⁴ M. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 7 presents filtration results of positively charged 2,3-diaminonaphthalene 10⁻⁴M, dissolved with 1M HCl. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 8 presents filtration results of neutral 2,3-dihydroxynaphtalene 10⁻⁴M. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 9 presents filtration results of ferric chloride FeCl₃ which is colored and easily detected, most of the salt according to UV-vis spectroscopy was captured. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 10 presents filtration results of chloroauric acid HAuCl₄ 10⁻³M, a negatively charged metal ion. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 11 presents filtration results of Cr⁶⁺ present in Sodium dichromate dihydrate 10⁻⁴ M, Na₂Cr₂O₇. Cr ions were almost absent in the filtrate according to UV-vis spectroscopy. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 12 presents filtration results of antibiotics Amoxicillin dissolved in water with 5 drops of NaOH 1M, 10⁻³M. Quantitative removal was observed using UV-vis. Using mixture of 5% PDI of formula II wherein o is 13 (PEG 13) with 95% PDI of formula II wherein o is 17 (PEG 17) membrane prepared with 2% THF:H₂O 2:98 v/v.

FIG. 13 presents PES after deposition of 0.5 ml 10% w/w Nafion-cross section energy-dispersive X-ray spectroscopy (EDS, 5 kV) a) mapped areas containing fluorine. b) mapped areas containing sulfur. c) mapped areas containing carbon. d) mapped areas containing oxygen. e) SEM image of the cross section. f) EDS X-ray spectrum of the PES/Nafion.

FIG. 14 presents UV/Vis spectrum of Amoxicillin before and after filtration on a 20 mg Nafion hybrid membrane (10⁻³M, dissolved with 5 drops of NaOH 1M).

FIG. 15 depicts cross section EDS (15 kV) of the filtration system of this invention, a) mapped areas containing cadmium. b) mapped areas containing fluorine. c) EDS X-ray spectrum of the Nafion/cadmium layer. d) mapped areas containing sulfur. e) mapped areas containing carbon. f) mapped areas containing oxygen.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In one embodiment, this invention is directed to a filtration system comprising a solid support, a perylene diimide (PDI) based membrane layer and a polymer layer. In another embodiment, the PDI based membrane layer is between the solid support and the polymer layer.

In one embodiment, this invention is directed to a filtration system comprising a solid support, a perylene diimide (PDI) based membrane layer which is situated on top of the solid support, a polymer layer which is situated on top of the PDI based membrane layer, and another perylene diimide (PDI) based membrane layer which is situated on top of the polymer layer.

In another embodiment, a perylene diimide (PDI) based membrane refers to a membrane comprising one or more of PDI compounds of formula I-XVI.

In one embodiment, this invention is directed to an apparatus comprising the filtration system of this invention.

In one embodiment, the filtration system, apparatus and methods of use thereof comprise and make use of peylene diimide based membrane layer.

In one embodiment, the perylene diimide based membrane layer of the filtration system of this invention comprises one or more self-assembled perylene diimide (PDI) compounds. In another embodiment, the perylene diimide based membrane layer of the filtration system of this invention comprises one or more self-assembled perylene diimide (PDI) compounds, each comprises PEG side chains in different length. In another embodiment, the PEG side chains comprise between 17-23 repeating units. In another embodiment, the PEG side chains comprise between 13-25 repeating units. In another embodiment, the PEG side chains comprise between 13-50 repeating units. In another embodiment, the PEG side chains comprise 13 repeating units [PEG13=—(CH₂CH₂O)₁₃—CH₃ or —(CH₂CH₂O)₁₃—H]. In another embodiment, the PEG side chains comprise 17 repeating units [PEG17=—(CH₂CH₂O)₁₇—CH₃ or —(CH₂CH₂O)₁₇—H)]. In another embodiment, the PEG side chains comprise 23 repeating units [PEG23=—(CH₂CH₂O)₂₃—CH₃ or —(CH₂CH₂O)₂₃—H].

Hydrophobic interactions between large nonpolar groups of amphiphilic molecules in aqueous solution can be remarkably strong, driving self-assembly towards very stable supramolecular systems. The PDI compounds of this invention comprise two covalently attached perylene-3,4,9,10-tetracarboxylic acid diimide (PDI) units with PEG side chains. These compounds self-assemble in aqueous media into a robust three dimensional (3D) fibrous network, resulting in a stable and multiple-stimuli-responsive membrane.

In one embodiment, the PDI based membrane layer of the filtration system of this invention is based on very strong hydrophobic interactions, preventing exposure of the hydrophobic moieties to bulk water. It is also enclosed by a shell of polyethylene glycol (PEG) groups, which are known to preserve the native structure of proteins and resist undesired biomolecule adsorption. Thus, in water, the PDI based membrane layer of this invention is robust and potentially biocompatible.

In one embodiment, the perylene diimide based membrane layer of the filtration system of this invention comprises one or more self-assembled perylene diimide (PDI) compounds, wherein each of said perylene diimide (PDI) compounds is represented by the structure of formula I:

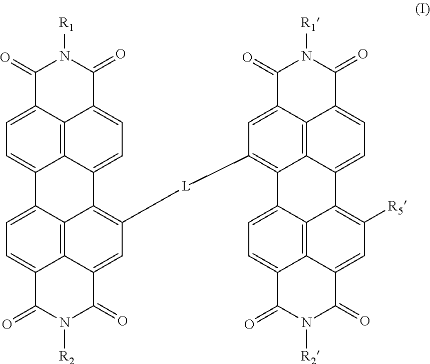

wherein

R₁ and R₁′ are each independently [(CH₂)_{q}O]ᵣCH₃, [(CH₂)_{q}O]ᵣH [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₃NH]ₚH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₈)alkyl or (C₁-C₈)alkyl; and wherein R₃ in said [C(O)CHR₃NH]ₚH is an alkyl, haloalkyl, hydroxyalkyl, hydroxyl, aryl, phenyl, alkylphenyl, alkylamino and independently the same or different when p is larger than 1;

R₂ and R₂′ are each independently [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₄NH]ₛH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₈)alkyl or (C₁-C₈)alkyl; and wherein R₄ in said [C(O)CHR₄NH]ₛH is an alkyl, haloalkyl, hydroxyalkyl, hydroxyl, aryl, phenyl, alkylphenyl, alkylamino and independently the same or different when s is larger than 1;

R₅ and R₅′ are each independently H, —ORₓ where Rₓ is C₁-C₆ alkyl, [(CH₂)ₙO]ₒCH₃ or [(CH₂)ₙO]ₒH; [(CH₂)C(O)O]ₒCH₃, [(CH₂)C(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)O]ₒCH₃, [(alkylene)C(O)O]ₒCH₃, [(alkylene)C(O)NH]ₒCH₃, [(alkylene)ₙCH₂═CH₂]ₒCH₃, [(alkylene)ₙCH≡CH]ₒCH₃, [(alkylene)ₙNH]ₒCH₃, aryl, heteroaryl, C≡C—R₇, CH═CR₈R₉, NR₁₀R₁₁, chiral group, amino acid, peptide or a saturated carbocyclic or heterocyclic ring wherein said saturated heterocyclic ring or heteroaryl contains at least one nitrogen atom and R₅ or R₅′ are connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);

R₇ is H, halo, (C₁-C₃₂)alkyl, aryl, NH₂, alkyl-amino, COOH, C(O)H, alkyl-COOH heteroaryl, Si(H)₃ or Si[(C₁-C₈)alkyl]₃ wherein said aryl or heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);

R₈, R₉, R₁₀ and R₁₁ are each independently H, (C₁-C₃₂)alkyl, aryl, NH₂, alkyl-amino, COOH, C(O)H, alkyl-COOH or heteroaryl wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);

L is a linker;

n is an integer from 1-5;

o is an integer from 1-100;

p is an integer from 1-100;

q is an integer from 1-5;

r is an integer from 1-100; and

s is an integer from 1-100;

wherein if R₅ and/or R₅′ are chiral; said membrane will form a chiral membrane.

In one embodiment, the perylene diimide based membrane layer of the filtration system of this invention comprises one or more self-assembled perylene diimide (PDI) compounds, wherein each of said perylene diimide (PDI) compounds is represented by the structure of formula II:

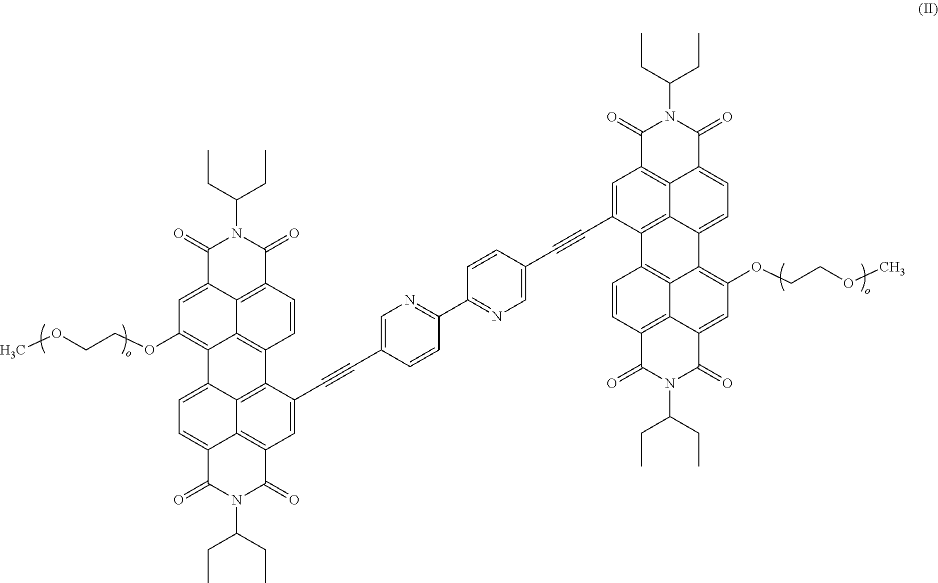

wherein o is an integer between 1 to 100.

In another embodiment, said perylene diimide based membrane layer of the filtration system of this invention comprises between 2 to 10 perylene diimide compounds of formula II, each has a different integer “o”.

In one embodiment, the PDI based membrane layer of the filtration system of this invention comprises a mixture of between 2 to 10 perylene diimide compounds of this invention. In another embodiment, the PDI based membrane of the filtration system of this invention comprises 2 perylene diimide compounds of this invention. In another embodiment, the PDI based membrane of the filtration system of this invention comprises 3 perylene diimide compounds of this invention. In another embodiment, the PDI based membrane of the filtration system of this invention comprises 4 perylene diimide compounds of this invention. In another embodiment, the PDI based membrane of the filtration system of this invention comprises 5 perylene diimide compounds of this invention. In another embodiment, the PDI based membrane of the filtration system of this invention comprises 6 perylene diimide compounds of this invention. In another embodiment, the PDI based membrane of the filtration system of this invention comprises between 7 to 10 perylene diimide compounds of this invention.

In one embodiment, the noncovalent self-assembled porous PDI based membrane layer of the filtration system of this invention comprise a supramolecular structure comprising perylene diimide compound of formula II, wherein o is 13, as a monomeric unit. In another embodiment, the noncovalent self-assembled porous membrane layer of the filtration system of this invention comprises a supramolecular structure comprising perylene diimide of formula II, wherein o is 17, as a monomeric unit. In another embodiment, the noncovalent self-assembled porous PDI based membrane layer of the filtration system of this invention comprise a supramolecular structure comprising perylene diimide of formula II, wherein o is 23, as a monomeric unit. In another embodiment, the noncovalent self-assembled porous PDI based membrane layer of the filtration system of this invention comprise a supramolecular structure comprising perylene diimide of formula II, wherein o is 44, as a monomeric unit.

In another embodiment, the noncovalent self-assembled porous PDI based membrane layer of the filtration system of this invention comprise a supramolecular structure comprising a mixture of perylene diimide compounds of this invention.

In another embodiment, the PDI based membrane layer of the filtration system of this invention comprise a supramolecular structure comprising a mixture of two or more perylene diimide compounds of formula II, wherein o is between 13-44 for each compound.

In another embodiment, the PDI based membrane layer of the filtration system of this invention comprise a supramolecular structure comprising a mixture of perylene diimide compound of formula II wherein o is 23, with a perylene diimide compound of formula II wherein o is 13.

In another embodiment, the noncovalent self-assembled porous PDI based membrane layer of the filtration system of this invention comprise a supramolecular structure comprising a mixture of perylene diimide compound of formula II wherein o is 13 with a perylene diimide compound of formula II wherein o is 44.

In another embodiment, the noncovalent self-assembled porous PDI based membrane layer of the filtration system of this invention comprise a supramolecular structure comprising a mixture is of perylene diimide compound of formula II wherein o is 13, with a perylene diimide compound of formula II wherein o is 17.

In another embodiment, the PDI based membrane layer of the filtration system of this invention comprises a mixture of two compounds of formula II, in a molar ratio of 70:30, 75:25, 80:20, 85:15, 90:10, 95:5, 96:4, 97:3, 98:2 or 99:1 (% mol/% mol).

In another embodiment, the PDI based membrane layer of the filtration system of this invention comprises a mixture of 95% (% mol) of compound of formula II wherein o is 17, and 5% (% mol) of a compound of formula II, wherein o is 13.

In another embodiment, the PDI based membrane of the filtration system of this invention comprises 95% (% mol) of compound of formula II wherein o is 13 and 5% (% mol) of a compound of formula II, wherein o is 23.

In one embodiment, the self-assembled perylene diimide based membrane layer of the filtration system of this invention comprises one or more perylene diimide (PDI) compounds, wherein each of said perylene diimide (PDI) compounds is represented by the structure of formula III:

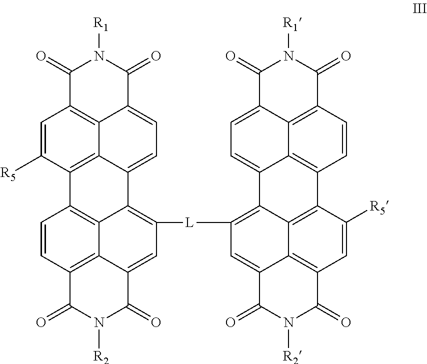

wherein R₁, R₂, R₁′, R₂′, R₅, R₅′ and L are as described in formula I.

In one embodiment, the self-assembled perylene diimide based membrane layer of the filtration system of this invention comprises one or more perylene diimide (PDI) compounds, wherein each of said perylene diimide (PDI) compounds is represented by the structure of formula IV:

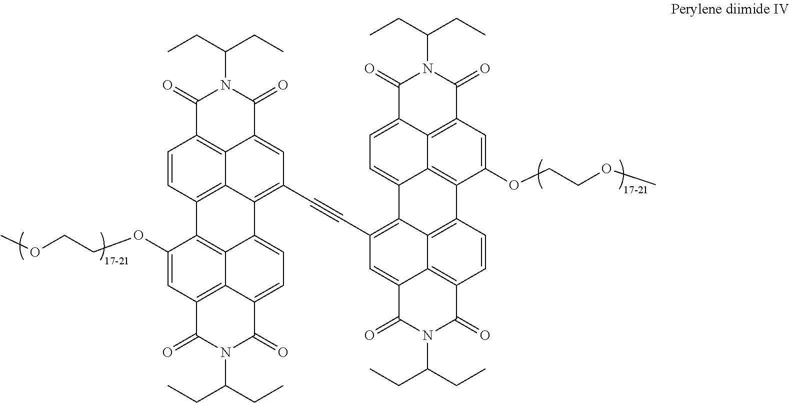

In one embodiment, the self-assembled perylene diimide based membrane layer of the filtration system of this invention comprises one or more perylene diimide (PDI) compounds, wherein each of said perylene diimide (PDI) compounds is represented by the structure of formula V:

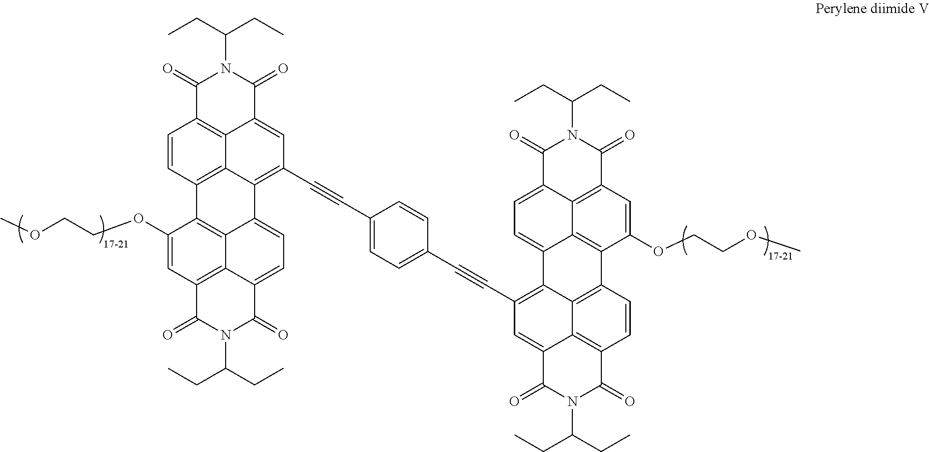

In one embodiment, the self-assembled perylene diimide based membrane layer of the filtration system of this invention comprises one or more perylene diimide (PDI) compounds, wherein each of said perylene diimide (PDI) compounds is represented by the structure of formula VI:

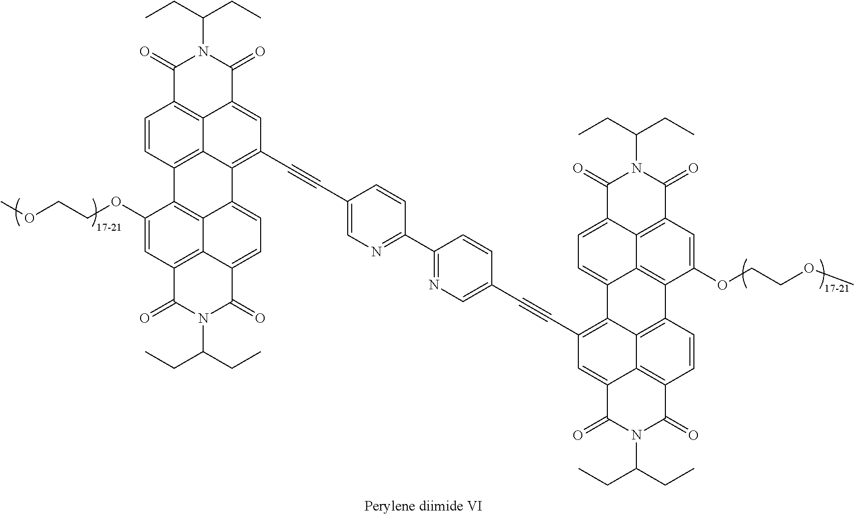

In one embodiment, the self-assembled perylene diimide based membrane layer of the filtration system of this invention comprises one or more perylene diimide (PDI) compounds, wherein each of said perylene diimide (PDI) compounds is represented by the structure of formula Perylene diimide VI-Pt complex:

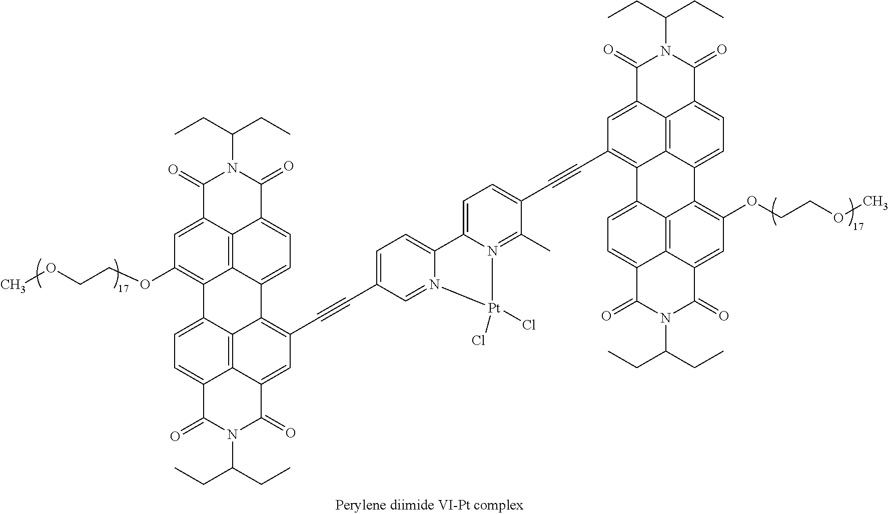

In one embodiment, the self-assembled perylene diimide based membrane layer of the filtration system of this invention comprises one or more perylene diimide (PDI) compounds, wherein each of said perylene diimide (PDI) compounds is represented by the structure of formula VII:

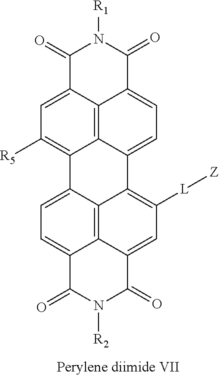

wherein
   R₁ is [(CH₂)_{q}O]ᵣCH₃, [(CH₂)_{q}O]ᵣH[(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₃NH]ₚH; wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);
      wherein A comprises three same or different of the following substituents Cl, Br, I, O(C₁-C₈)alkyl or (C₁-C₈)alkyl; and
wherein R₃ in said [C(O)CHR₃NH]ₚH is an alkyl, haloalkyl, hydroxyalkyl, hydroxyl, aryl, phenyl, alkylphenyl, alkylamino and independently the same or different when p is larger than 1
   R₂ is [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₄NH]ₛH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);
wherein A comprises three same or different of the following substituents Cl, Br, I, O(C₁-C₈)alkyl or (C₁-C₈)alkyl; and
wherein R₄ in said [C(O)CHR₄NH]₈H is an alkyl, haloalkyl, hydroxyalkyl, hydroxyl, aryl, phenyl, alkylphenyl, alkylamino and independently the same or different when s is larger than 1;
R₅ is H, —ORₓ where Rₓ is C₁-C₆ alkyl, [(CH₂)ₙO]ₒCH₃ or [(CH₂)ₙO]ₒH; [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)O]ₒCH₃, [(alkylene)C(O)O]ₒCH₃, [(alkylene)C(O)NH]ₒCH₃, [(alkylene)CH₂═CH₂]ₒCH₃, [(alkylene)ₙCH≡CH]ₒCH₃, [(alkylene)ₙNH]ₒCH₃, aryl, heteroaryl, C≡C—R₇, CH═CR₈R₉, NR₁₀R₁₁, chiral group, amino acid, peptide or a saturated carbocyclic or heterocyclic ring wherein said saturated heterocyclic ring or heteroaryl contains at least one nitrogen atom and R₅ or R₅′ are connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);
Z is —ORₓ where Rₓ is C₁-C₆ alkyl, [(CH₂)_{q}O]ᵣH, or [(CH₂)_{q}O]ᵣCH₃, peptide, amino-acid, chiral group, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, aryl, heteroaryl, C≡C—R₇, CH═CR₈R₉, NR₁₀R₁₁ or a saturated carbocyclic or heterocyclic ring wherein said saturated heterocyclic ring or heteroaryl contains at least one nitrogen atom and Z is connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);
R₇ is H, halo, (C₁-C₃₂)alkyl, aryl, NH₂, alkyl-amino, COOH, C(O)H, alkyl-COOH heteroaryl, Si(H)₃ or Si[(C₁-C₅)alkyl]₃ wherein said aryl or heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);
R₈, R₉, R₁₀ and R₁₁ are each independently H, (C₁-C₃₂)alkyl, aryl, NH₂, alkyl-amino, COOH, C(O)H, alkyl-COOH or heteroaryl wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);
L is a linker or a bond;
n is an integer from 1-5;
o is an integer from 1-100;
p is an integer from 1-100;
q is an integer from 1-5;
r is an integer from 1-100; and
s is an integer from 1-100;
   wherein if Z is a chiral group; said membrane will form a chiral membrane.

In one embodiment, the self-assembled perylene diimide based membrane layer of the filtration system of this invention comprises one or more perylene diimide (PDI) compounds, wherein each of said perylene diimide (PDI) compounds is represented by the structure of formula VIII:

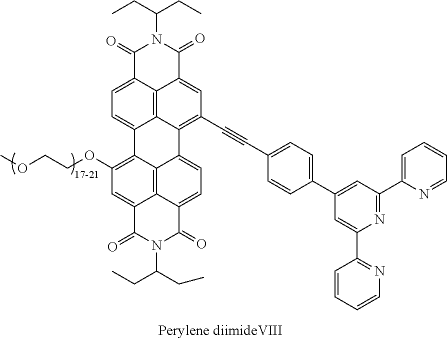

In one embodiment, the self-assembled perylene diimide based membrane layer of the filtration system of this invention comprises one or more perylene diimide (PDI) compounds, wherein each of said perylene diimide (PDI) compounds is represented by the structure of formula VIII-Pd Complex:

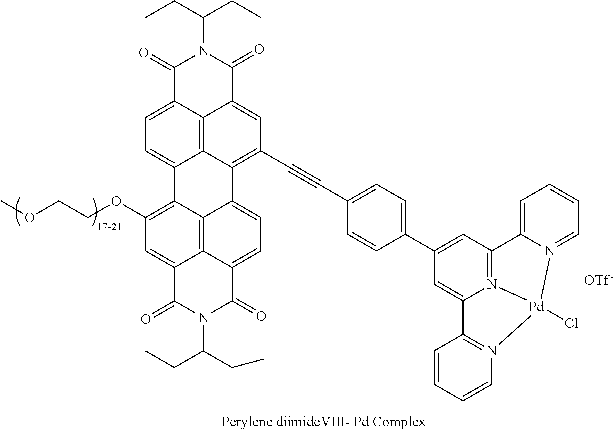

In one embodiment, the self-assembled perylene diimide based membrane layer of the filtration system of this invention comprises one or more perylene diimide (PDI) compounds, wherein each of said perylene diimide (PDI) compounds is represented by the structure of formula VIII-Pt Complex:

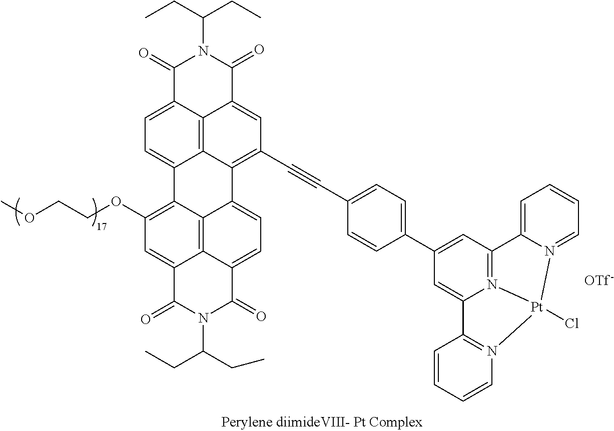

In one embodiment, the self-assembled perylene diimide based membrane layer of the filtration system of this invention comprises one or more perylene diimide (PDI) compounds, wherein each of said perylene diimide (PDI) compounds is represented by the structure of formula VIII-Ag Complex:

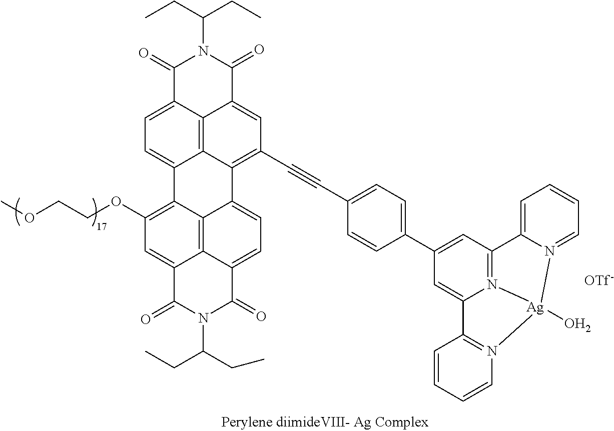

In one embodiment, the PDI based membrane layer of the filtration system of this invention and methods of use thereof comprise and make use of supramolecular structure comprising a chiral perylene diimide, a salt thereof or a metal complex thereof wherein said perylene diimide is represented by the structure of formula I wherein R₅ or R₅′ are independently a chiral group, an amino acid or a peptide. In another embodiment, said perylene diimide is represented by the structure of formula VII wherein Z is a chiral group, an amino acid or a peptide. In another embodiment, said perylene diimide is represented by the structure of formula VII wherein Z is a chiral group, an amino acid or a peptide and R₅ is a PEG substituted by a chiral group.

In one embodiment, the noncovalent self-assembled porous and chiral PDI based membrane of the filtration system this invention comprises a supramolecular structure of one or more perylene diimide (PDI) compounds, wherein each of said perylene diimide (PDI) compounds is a chiral perylene diimide compound, a salt thereof or a metal complex thereof wherein said perylene diimide is represented by the following structures:

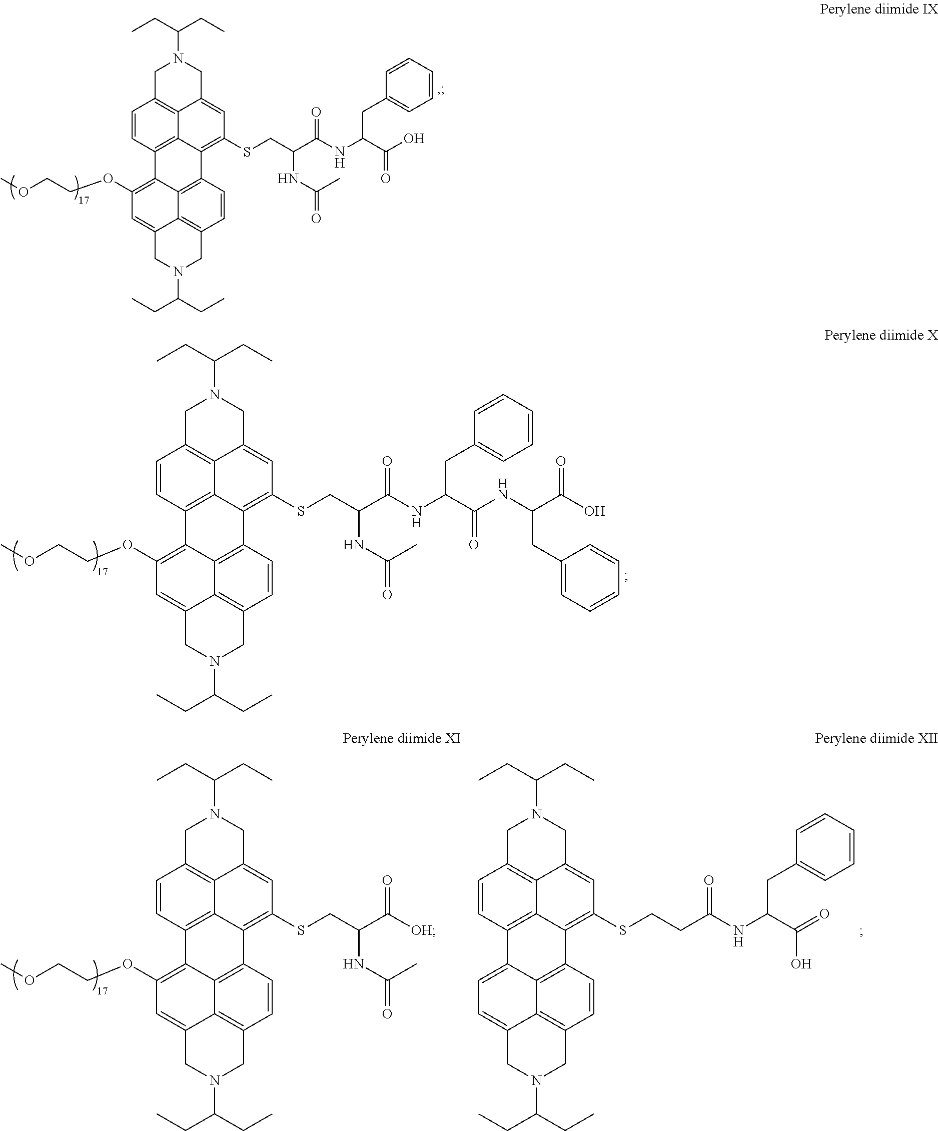

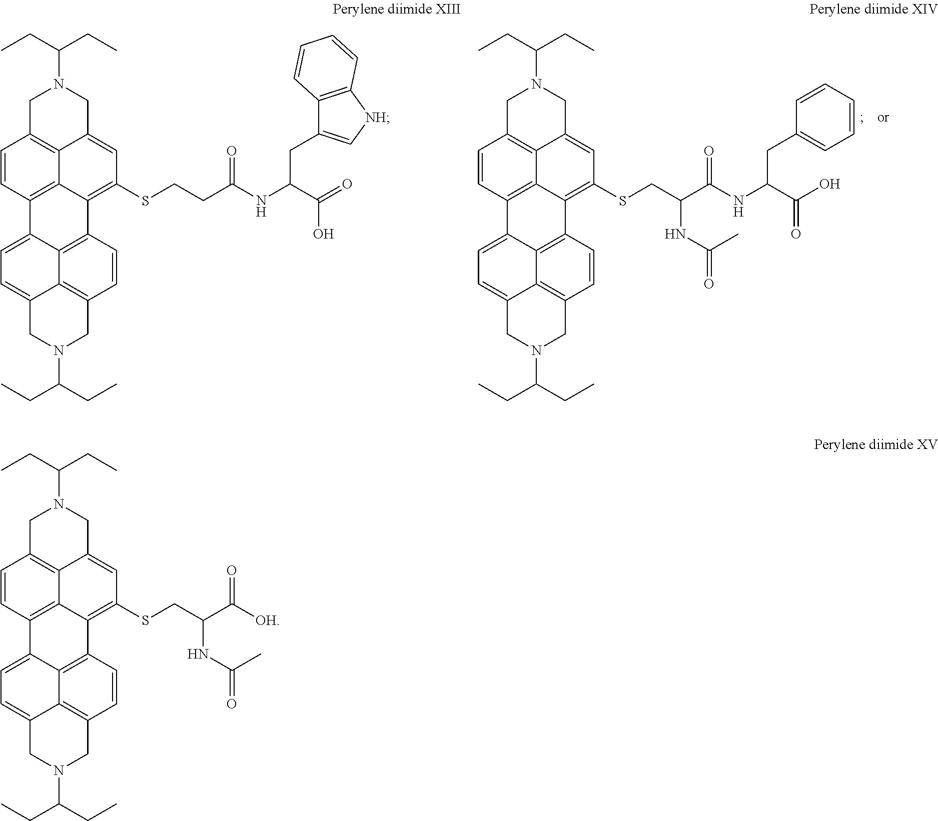 [SMILES: CCC(CC)N1Cc2ccc3c4ccc5c6c(cc(SCCC(=O)NC(Cc7c[nH]c8ccccc78)C(=O)O)c(c7ccc(c2c37)C1)c64)CN(C(CC)CC)C5 ; CCC(CC)N1Cc2ccc3c4ccc5c6c(cc(SCC(NC(C)=O)C(=O)NC(Cc7ccccc7)C(=O)O)c(c7ccc(c2c37)C1)c64)CN(C(CC)CC)C5 ; CCC(CC)N1Cc2ccc3c4ccc5c6c(cc(SCC(NC(C)=O)C(=O)O)c(c7ccc(c2c37)C1)c64)CN(C(CC)CC)C5]

In one embodiment, the self-assembled perylene diimide based membrane layer of the filtration system of this invention comprises one or more perylene diimide (PDI) compounds, wherein each of said perylene diimide (PDI) compounds is represented by the structure of formula XVI:

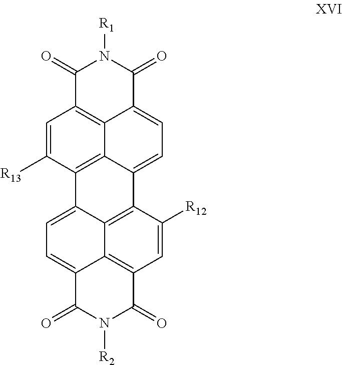

wherein
R₁ is [(CH₂)_{q}O]ᵣCH₃, [(CH₂)_{q}O]ᵣH[(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₃NH]ₚH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₅)alkyl or (C₁-C₅)alkyl; and wherein R₃ in said [C(O)CHR₃NH]ₚH is an alkyl, haloalkyl, hydroxyalkyl, hydroxyl, aryl, phenyl, alkylphenyl, alkylamino and independently the same or different when p is larger than 1;
R₂ is [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₄NH]₈H wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₈)alkyl or (C₁-C₈)alkyl; and wherein R₄ in said [C(O)CHR₄NH]₈H is an alkyl, haloalkyl, hydroxyalkyl, hydroxyl, aryl, phenyl, alkylphenyl, alkylamino and independently the same or different when s is larger than 1;
R₁₂ is H, halogen, alkylamino, OH, NH₂, NO₂, CN, alkoxy or N(alkyl)₂;
R₁₃ is H, halogen, alkylamino, OH, NH₂, NO₂, CN, alkoxy or N(alkyl)₂;
   wherein at least one of R₁₂ or R₁₃ is not hydrogen.
p is an integer from 1-100;
q is an integer from 1-5;
r is an integer from 1-100; and
s is an integer from 1-100.

In one embodiment, this invention is directed to filtration system, apparatus and methods of use thereof comprising a noncovalent self-assembled porous PDI based membrane layer. In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula I, wherein said mixture comprises between 2 to 10 different perylene diimide compounds of formula I.

In another embodiment, the PDI membrane layer comprises a perylene diimide supramolecular structure, wherein said perylene diimide supramolecular structure comprises a mixture of perylene diimide compounds, wherein each perylene diimide compound is represented by the structure of formula II, wherein said mixture comprises between 2 to 10 different perylene diimide compounds of formula II, each has a different “o” integer.

In another embodiment, the PDI membrane layer comprises a perylene diimide supramolecular structure, wherein said perylene diimide supramolecular structure comprises a mixture of perylene diimide compounds, wherein each perylene diimide compound is represented by the structure of formula III, wherein said mixture comprises between 2 to 10 different perylene diimide compounds of formula III.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula IV, wherein said mixture comprises between 2 to 5 different perylene diimide compounds of formula IV, and wherein said compounds, are different in their side chains PEG size. In one embodiment, the side chain PEG size of each compound is independently PEG17, PEG18, PEG19, PEG20 or PEG21. [PEG17 refers to an average of 17 repeating units, PEG 18 refers to an average of 18 repeating units, etc . . . ]

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula V, wherein said mixture comprises between 2 to 5 different perylene diimide compounds of formula V, and wherein said compounds are different in their side chains PEG size. In one embodiment, the side chains PEG size of each compound is independently PEG17, PEG18, PEG19, PEG20 or PEG21.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula VI, wherein said mixture comprises between 2 to 5 different perylene diimide compounds of formula VI, and wherein said compounds are different in their side chains PEG size. In one embodiment, the side chains PEG size of each compound is independently PEG17, PEG18, PEG19, PEG20 or PEG21.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula VII, wherein said mixture comprises between 2 to 10 different perylene diimide compounds of formula VII.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula VIII, wherein said mixture comprises between 2 to 10 different perylene diimide compounds with different side chains PEG size or different metal complexes formula VI of formula VIII.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula IX-XV, wherein said mixture comprises between 2 to 10 different perylene diimide compounds of formula IX-XV.

In another embodiment, the PDI based membrane layer comprises a perylene diimide supramolecular structure comprising a perylene diimide compound represented by the structure of formula XVI.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula XVI, wherein said mixture comprises between 2 to 10 different perylene diimide compounds of formula XVI.

In another embodiment, the PDI based membrane layer comprises a perylene diimide supramolecular structure, wherein said perylene diimide supramolecular structure comprises a mixture of perylene diimide compounds, wherein each perylene diimide compound is represented by the structure of formula I-XVI, wherein said mixture comprises between 2 to 10 different perylene diimide compounds of formula I-XVI.

In one embodiment L of formula I, III or VII is an unsaturated bridge. In another embodiment, L of formula VII is saturated or unsaturated bridge. In one embodiment an unsaturated bridge of this invention is acetylene. In one embodiment an unsaturated bridge of this invention is phenylacetylene. In another embodiment an unsaturated bridge of this invention comprises an acetylene. In another embodiment an unsaturated bridge of this invention comprises a pyridyl. In another embodiment an unsaturated bridge of this invention comprises a bipyridyl. In another embodiment an unsaturated bridge of this comprises a terpyridyl. In another embodiment an unsaturated bridge of this invention comprises a phenyl. In another embodiment an unsaturated bridge of this comprises a dibenzene. In another embodiment an unsaturated bridge of this invention comprises diethynylbenzene. In another embodiment an unsaturated bridge of this invention comprises aryl. In another embodiment an unsaturated bridge of this invention comprises diethynyl-bipyridyl. In one embodiment an unsaturated bridge of this invention comprises bis-acetylene. In another embodiment an unsaturated bridge of this invention is a pyridyl group. In another embodiment an unsaturated bridge of this invention is a bipyridyl group. In another embodiment an unsaturated bridge of this invention is a terpyridyl group. In one embodiment L of formula I and III is a saturated bridge. In another embodiment a saturated bridge of this invention comprises an alkyl, cycloalkyl, heterocycle, ether, polyether, or haloalkyl. In one embodiment L of formula I and III is a combination of a saturated and unsaturated groups as defined hereinabove. In another embodiment, L of formula VII is an unsaturated bridge. In another embodiment, L of formula VII is an unsaturated bridge including —S—(CH₂)ₜ—C(O), —S—(CH₂)ₜ—O—, —O—(CH₂)ₜ—O— —NH—(CH₂)ₜ—C(O)—, —C(O)—(CH₂)ₜ—CO—, —C(O)—(CH₂)ₜ—NH— wherein t is between 1 to 6.

In another embodiment L of formula I, III or VII is:

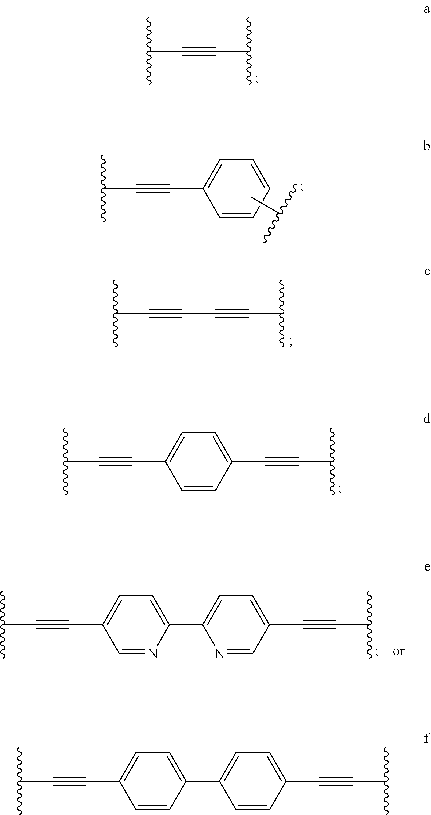

In one embodiment R₅ and/or R₅′ of formula I, III and VII are each independently a hydrophilic side chain. In another embodiment R₅ and/or R₅′ of formula I and III and VII are each independently a PEG (polyethylene glycol). In another embodiment the PEG of this invention comprises between 15-20 units. In another embodiment the PEG comprises between 17-21 repeating units. In another embodiment the PEG comprises between 18-22 repeating units. In another embodiment the PEG comprises about 19 repeating units. In another embodiment the PEG comprises between 13 to 25 repeating units. In another embodiment the PEG comprises between 18 to 24 repeating units. In another embodiment the PEG comprises between 10 to 30 repeating units. In another embodiment the PEG is capped with an alkyl group. In another embodiment the PEG is capped with a methyl group. In another embodiment the PEG is capped with an OH group. In one embodiment, R₅ and/or R₅′ of formula I, III and VII (or the side chains of the perylene diimide monomers) are each independently —OR^{x} where Rₓ is C₁-C₆ alkyl, [(CH₂)ₙO]ₒCH₃ or [(CH₂)ₙO]ₒH. In another embodiment, R₅ and/or R₅′ of formula I, III and VII are each independently —OR^{x} where Rₓ is [(CH₂)O]ₒCH₃ or [(CH₂)ₙO]ₒH and n is 2 or 3. In another embodiment, R₅ and/or R₅′ are each independently —OR^{x} where Rₓ is [(CH₂)ₙO]ₒCH₃, n is 2 and o is 17. In another embodiment, the perylene diimides comprise different lengths of PEG size chains, wherein the average lengths is of the side chains is between 13-25, 17-22 or 18-22 repeating units.

In one embodiment R₁, R₁′, R₂ and R₂ are the same. In another embodiment, R₁, R₁′, R₂ and R₂ are different. In another embodiment, R₁, R₁′, R₂ and/or R₂ are each independently an alkyl. In another embodiment, R₁, R₁′, R₂ and/or R₂ are each independently —CH(CH₂CH₃)₂. In another embodiment, R₁, R₁′, R₂ and/or R₂ are each independently a phenyl. In another embodiment, R₁, R₁′, R₂ and/or R₂ are each independently a CH₂-phenyl. In another embodiment, R₁, R₁′, R₂ and/or R₂ are each independently a PEG. In another embodiment, R₁, R₁′, R₂ and/or R₂ are each independently a chiral group.

In one embodiment, “r” of R₁, R₁′, R₂, and/or R₂′ of formula I, III, VII and XVI in the following substituents [(CH₂)_{q}O]ᵣCH₃, [(CH₂)_{q}O]ᵣH, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣH₃, [(alkylene)_{q}CH≡CH]ᵣCH₃, [(alkylene)_{q}NH]ᵣCH₃, is between 1-100. In another embodiment “r” is between 15-20. In another embodiment “r” is between 10-20. In another embodiment “r” is between 17-22. In another embodiment “r” is about 19. In another embodiment “r” is between 10-30. In another embodiment “r” is between 20-40. In another embodiment “r” is between 20-50.

In one embodiment, “o” of R₅ and/or R₅′ formula I, III and VII in the following substituents ORₓ, wherein Rₓ is [(CH₂)ₙO]ₒCH₃ or [(CH₂)ₙO]ₒH; or wherein R₅ and/or R₅′ formula I, III and VII are independently each [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)O]ₒCH₃, [(alkylene)ₙC(O)O]ₒCH₃, [(alkylene)C(O)NH]ₒCH₃, [(alkylene)CH₂═CH₂]CH₃, [(alkylene)ₙCH≡CH]ₒCH₃, [(alkylene)ₙNH]ₒCH₃ is between 1-100. In another embodiment “o” is between 15-20. In another embodiment “o” is between 10-20. In another embodiment “o” is between 17-22. In another embodiment “o” is about 19. In another embodiment “o” is between 13-23. In another embodiment “o” is between 10-30. In another embodiment “o” is between 20-40. In another embodiment “o” is between 20-50.

In one embodiment “p” of R₃ formula I, III and VII in the following substituent [C(O)CHR₃NH]ₚH is between 1-100. In another embodiment “p” is between 15-20. In another embodiment “p” is between 10-20. In another embodiment “p” is between 17-22. In another embodiment “p” is about 19. In another embodiment “p” is between 10-30. In another embodiment “p” is between 20-40. In another embodiment “p” is between 20-50.

In one embodiment “n” of R₅ and/or R₅′ formula I, III and VII in the following substituent [(CH₂)ₙO]ₒCH₃, [(CH₂)ₙO]ₒH, [(CH₂)C(O)O]ₒCH₃, [(CH₂)C(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)_{q}O]ₒCH₃, [(alkylene)ₙC(O)O]ₒCH₃, [(alkylene)ₙC(O)NH]ₒCH₃, [(alkylene)CH₂═CH₂]ₒCH₃, [(alkylene)ₙCH≡CH]ₒCH₃, [(alkylene)ₙNH]ₒCH₃ is between 1-5. In another embodiment “n” is 1. In another embodiment “n” is 2. In another embodiment “n” is 3. In another embodiment “n” is 4. In another embodiment “n” is 5.

In one embodiment “q” of R₁, R₁′, R₂ and/or R₂′ formula I, III, VII and XVI in the following substituent independently [(CH₂)_{q}O]ᵣCH₃, [(CH₂)_{q}O]ᵣH, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, is between 1-5. In another embodiment “q” is 1. In another embodiment “q” is 2. In another embodiment “q” is 3. In another embodiment “q” is 4. In another embodiment “q” is 5.

In one embodiment “s” of R₄ formula I, III, VII and XVI in the following substituent [C(O)CHR₄NH]ₛH is between 1-100. In another embodiment “s” is between 15-20. In another embodiment “s” is between 10-20. In another embodiment “s” is between 17-22. In another embodiment “s” is about 19. In another embodiment “s” is between 10-30. In another embodiment “s” is between 20-40. In another embodiment “s” is between 20-50.

In one embodiment, Z of formula VII is —ORₓ where Rₓ is C₁-C₆ alkyl or [(CH₂)_{q}O]ᵣCH₃.

In one embodiment, Z of formula VII is a peptide. In another embodiment, Z is a peptide including between 2-4 amino acids. In another embodiment, Z is a peptide including between 2-6 amino acids. In another embodiment, Z is a peptide including between 2-10 amino acids. In another embodiment, the amino acids are protected amino acids. In another embodiment, Z of formula VII is a peptide wherein the peptide is attached to the linker (L) via one of the side chains of the amino acid. In another embodiment, Z of formula VII is a peptide wherein the peptide is attached to the linker (L) via the amino end. In another embodiment, Z of formula VII is a peptide wherein the peptide is attached to the linker (L) via the carboxylic end. In another embodiment, Z of formula VII is a peptide, L is a bond and the peptide is attached the perylene diimide directly via one of the side chains of the amino acid. In another embodiment, Z of formula VII is a peptide, L is a bond and the peptide is attached the perylene diimide directly via the amino end. In another embodiment, Z of formula VII is a peptide, L is a bond and the peptide is attached the perylene diimide directly via the carboxylic acid end. In another embodiment, Z of formula VII is a peptide, L is a bond and the peptide is attached the perylene diimide directly via the SH side chain of a cysteine amino acid. In another embodiment, the peptide is -Cys-Phe, In another embodiment, the peptide is -Cys-Phe-Phe. In another embodiment, the peptide is chiral.

In one embodiment, Z of formula VII is an amino acid. In another embodiment, the amino acid is Phe. In another embodiment, the amino acid is Trp. In another embodiment, the amino acid is Cys. In another embodiment, the amino acid is Tyr. In another embodiment the amino acid is not an enantiomeric mixture. In another embodiment, the amino acid is a pure enantiomer. In one embodiment, Z of formula VII is a chiral group. In another embodiment, R₁, R₁′, R₂, R₂′, R₅ and/or R₅′ of formula I, III, and VII are each independently a chiral group. In another embodiment, “chiral group” refers to any group that lack symmetry. Non limiting examples of chiral group include an amino acid, an artificial amino acid, a peptide, a protein, a sugar, DNA, RNA, a nucleic acid, chiral drug, chiral molecule or combination thereof.

In one embodiment, Z of formula VII is [(CH₂)_{q}C(O)O]ᵣCH₃. In another embodiment, Z of formula VII is [(CH₂)_{q}C(O)NH]ᵣCH₃. In another embodiment, Z of formula VII is [(CH₂)_{q}CH₂═CH₂]ᵣCH₃. In another embodiment, Z of formula VI is [(CH₂)_{q}CH≡CH]ᵣCH₃. In another embodiment, Z of formula VII is [(CH₂)_{q}NH]ᵣCH₃. In another embodiment, Z of formula VII is [(alkylene)_{q}O]ᵣCH₃. In another embodiment, Z of formula VII is [(alkylene)_{q}C(O)O]ᵣCH₃. In another embodiment, Z of formula VII is [(alkylene)_{q}C(O)NH]ᵣCH₃. In another embodiment, Z of formula VII is [(alkylene)_{q}CH₂═CH₂]ᵣCH₃. In another embodiment, Z of formula VII is [(alkylene)_{q}CH≡CH]ᵣCH₃. In another embodiment, Z of formula VII is [(alkylene)_{q}NH]ᵣCH₃. In another embodiment, Z of formula VII isaryl. In another embodiment, Z of formula VII is heteroaryl. In another embodiment, Z of formula VII is C≡C—R₇. In another embodiment, Z of formula VII is CH═CR₈R₉. In another embodiment, Z of formula VII is NR₁₀R₁₁. In another embodiment, Z of formula VII is saturated carbocyclic or heterocyclic ring. In another embodiment, Z of formula VII is bipyridyl, terpyridyl or metal complex thereof.

In one embodiment the filtration system, apparatus and methods of use thereof comprise and make use of PDI compound or its metal complex. In another embodiment the metal complex is a Pd (IV), Pt(II), Ag(I) or any other transition metal complex of pyridyls, bipyridyls, terpyridyl or any other chelating linkers known in the art.

In one embodiment, R₁₂ of formula XVI is H, halogen, alkylamino, OH, NH₂, NO₂, CN, alkoxy or N(alkyl)₂. In another embodiment R₁₂ is hydrogen. In another embodiment R₁₂ is halogen (halide). In another embodiment R₁₂ is F. In another embodiment R₁₂ is Cl. In another embodiment R₁₂ is Br. In another embodiment R₁₂ is I. In another embodiment R₁₂ is alkylamino. In another embodiment R₁₂ is OH. In another embodiment R₁₂ is NH₂. In another embodiment R₁₂ is NO₂. In another embodiment R₁₂ is CN. In another embodiment R₁₂ is alkoxy. In another embodiment R₁₂ is N(alkyl)₂. In another embodiment, R₁₂ is N(Me)₂. In another embodiment, R₁₂ is OMe.

In one embodiment, R₁₃ of formula XVI is H, halogen, alkylamino, OH, NH₂, NO₂, CN, alkoxy or N(alkyl)₂. In another embodiment R₁₃ is hydrogen. In another embodiment R₁₃ is halogen (halide). In another embodiment R₁₃ is F. In another embodiment R₁₃ is Cl. In another embodiment R₁₃ is Br. In another embodiment R₁₃ is I. In another embodiment R₁₃ is alkylamino. In another embodiment R₁₃ is OH. In another embodiment R₁₃ is NH₂. In another embodiment R₁₃ is NO₂. In another embodiment R₁₃ is CN. In another embodiment R₁₃ is alkoxy. In another embodiment R₁₃ is N(alkyl)₂. In another embodiment, R₁₃ is N(Me)₂. In another embodiment, R₁₃ is OMe.

An “alkyl” or “alkylene” group refers, in one embodiment, to a saturated aliphatic hydrocarbon, including straight-chain and branched-chain groups. In one embodiment, the alkyl group has 1-12 carbons. In another embodiment, the alkyl group has 1-8 carbons. In another embodiment, the alkyl group has 1-6 carbons. In another embodiment, the alkyl group has 1-4 carbons. The alkyl group may be unsubstituted or substituted by one or more groups selected from halogen, cyano, hydroxy, alkoxy carbonyl, amido, alkylamido, dialkylamido, nitro, amino, alkylamino, dialkylamino, carboxyl, thio and thioalkyl. In one embodiment, the alkyl group is —CH₃, —CH(CH₃)₂, —CH₂CH(CH₃)₂, —CH(CH₃)CH₂CH₃, and the like.

A “cycloalkyl” group refers, in one embodiment, to a saturated aliphatic cyclic hydrocarbon group. In one embodiment, the cycloalkyl group has 3-12 carbons. In another embodiment, the cycloalkyl group has 3-8 carbons. In another embodiment, the cycloalkyl group has 3-6 carbons. In another embodiment, the cycloalkyl group has 3 carbons. The cycloalkyl group may be unsubstituted or substituted by one or more groups selected from halogen, cyano, hydroxy, alkoxy carbonyl, amido, alkylamido, dialkylamido, nitro, amino, alkylamino, dialkylamino, carboxyl, thio and thioalkyl. In one embodiment, the cycloalkyl group is cyclopropyl, cyclobutyl, cyclopentyl, cyclohexyl, and the like. In another embodiment, the cycloalkyl comprises of between 1-4 rings.

The term “carbocyclic ring” refers to a saturated or unsaturated ring composed exclusively of carbon atoms. In one embodiment, the carbocyclic ring is a 3-12 membered ring. In another embodiment, the carbocyclic ring is a 3-8 membered ring. In one embodiment, the carbocyclic ring is a five membered ring. In one embodiment, the carbocyclic ring is a six membered ring. In one embodiment the carbocyclic ring may be unsubstituted or substituted by one or more groups selected from halogen, cyano, haloalkyl, hydroxy, alkoxy carbonyl, amido, alkylamido, dialkylamido, nitro, amino, alkylamino, dialkylamino, carboxy or thio or thioalkyl. Nonlimiting examples of carbocyclic ring are benzene, cyclohexane, and the like. In another embodiment, the carbocyclic ring comprises of between 1-4 rings.

The term “aryl” refers to an aromatic group having at least one carbocyclic aromatic ring, which may be unsubstituted or substituted by one or more groups selected from halogen, cyano, aryl, heteroaryl, haloalkyl, hydroxy, alkoxy carbonyl, amido, alkylamido, dialkylamido, nitro, amino, alkylamino, dialkylamino, carboxy or thio or thioalkyl. Nonlimiting examples of aryl rings are phenyl, naphthyl, and the like. In one embodiment, the aryl group is a 5-12 membered ring. In another embodiment, the aryl group is a 5-8 membered ring. In one embodiment, the aryl group is a five membered ring. In one embodiment, the aryl group is a six membered ring. In another embodiment, the aryl group comprises of 1-4 fused rings.

The term “arylalkyl” refers to an alkyl group as defined above substituted by an aryl group as defined above. Examples of arylalkyl, but not limited to are —CH₂Ph or —CH₂CH₂Ph.

The term “heteroaryl” refers to an aromatic group having at least one heterocyclic aromatic ring. In one embodiment, the heteroaryl comprises at least one heteroatom such as sulfur, oxygen, nitrogen, silicon, phosphorous or any combination thereof, as part of the ring. In another embodiment, the heteroaryl may be unsubstituted or substituted by one or more groups selected from halogen, aryl, heteroaryl, cyano, haloalkyl, hydroxy, alkoxy carbonyl, amido, alkylamido, dialkylamido, nitro, amino, alkylamino, dialkylamino, carboxy or thio or thioalkyl. Nonlimiting examples of heteroaryl rings are pyranyl, pyrrolyl, pyrazinyl, pyrimidinyl, pyrazolyl, pyridinyl, furanyl, thiophenyl, thiazolyl, indolyl, imidazolyl, isoxazolyl, and the like. In one embodiment, the heteroaryl group is a 5-12 membered ring. In one embodiment, the heteroaryl group is a five membered ring. In one embodiment, the heteroaryl group is a six membered ring. In another embodiment, the heteroaryl group is a 5-8 membered ring. In another embodiment, the heteroaryl group comprises of 1-4 fused rings. In one embodiment, the heteroaryl group is 1,2,3-triazole. In one embodiment the heteroaryl is a pyridyl. In one embodiment the heteroaryl is a bipyridyl. In one embodiment the heteroaryl is a terpyridyl.

The terms “halide” and “halogen” refer to in one embodiment to F, in another embodiment to Cl, in another embodiment to Br, in another embodiment to I.

A “heterocyclic” group refers to a heterocycle. In one embodiment, said heterocycle refers to a ring structure comprising in addition to carbon atoms, sulfur, oxygen, nitrogen, silicon or phosphorous or any combination thereof, as part of the ring. In another embodiment the heterocycle is a 3-12 membered ring. In another embodiment the heterocycle is a 6 membered ring. In another embodiment the heterocycle is a 5-7 membered ring. In another embodiment the heterocycle is a 4-8 membered ring. In another embodiment, the heterocycle group may be unsubstituted or substituted by a halide, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the heterocycle ring may be fused to another saturated or unsaturated cycloalkyl or heterocyclic 3-8 membered ring. In another embodiment, the heterocyclic ring is a saturated ring. In another embodiment, the heterocyclic ring is an unsaturated ring.

The term “hydroxylalkyl” refers to an alkyl as described above substituted by hydroxyl group. Nonlimiting examples of hydroxyalkyl are —CH₂OH, —CH₂CH₂OH and the like.

The term “alkylamino” refers to an alkyl as described above substituted by an amine group. Nonlimiting examples of alkylamono are —CH₂NH₂, —CH₂CH₂N(CH₃)₂, —(CH₂)₅NH₂ and the like.

In one embodiment, this invention is directed to a filtration system with pores size of between 0.2 to 1 nm. In another embodiment, the filtration system has pore size smaller than 1 nm.

In another embodiment, the materials are nanoparticles or biomolecules. In another embodiment, the materials are nanoparticles, heavy metal ions, salts, dyes, small organic molecules, pharmaceuticals.

In another embodiment, size-selective separation of nanoparticles is conducted on a filtration system comprising a PDI based membrane having pores size with a cutoff size of between 1-5 nm. In another embodiment, size-selective separation of biomolecules is conducted on a filtration system comprising a PDI based membrane having pores size with a cutoff size of between 7-10 nm.

In one embodiment, a cutoff size refers to a size larger than that of 95% of the particles in the filtrate.

In another embodiment, membrane cutoff values are known to depend on shape and deformability of the filtered particles. In another embodiment, the filtration system pores depend on the thickness of the PDI based membrane and the thickness of the polymer. In another embodiment, enlargement of the pores can be obtained by heating the filtration system. In another embodiment, enlargement of the pores can be obtained by increasing the temperature of the filtration system to a temperature between 30-60° C. In another embodiment, enlargement of the pores can be obtained by increasing the temperature of the filtration system to a temperature between 30-100° C.

In one embodiment, this invention is directed to a filtration system, apparatus and methods of use thereof which comprise and make use of a PDI based membrane layer. In one embodiment, the thickness of the PDI based membrane layer is between 5-15 μm. In one embodiment, the thickness of the PDI based membrane layer is between 10-15 μm. In one embodiment, the thickness of the PDI based membrane layer is between 5-50 μm. In another embodiment, the thickness of the PDI based membrane layer is between 40-50 μm.

In one embodiment, the filtration system, apparatus, and methods of use thereof of this invention comprise and make use of a solid support, a perylene diimide membrane layer and a polymer layer. In another embodiment, the PDI based membrane layer is located between the solid support and the polymer layer. In another embodiment, the polymer is Nafion.

In another embodiment, said peylene diimide membrane layer is situated on said solid support and said polymer layer is situated on said perylene diimide membrane layer. In another embodiment, the filtration system further comprises an additional PDI based membrane layer, which is situated on top of the polymer layer.

In one embodiment, this invention is directed to a filtration system comprising a solid support, a perylene diimide (PDI) based membrane layer which is situated on top of the solid support, a polymer layer which is situated on top of the PDI based membrane layer, and another perylene diimide (PDI) based membrane layer which is situated on top of the polymer layer.

In one embodiment, this invention provides a filtration system comprising a solid support with pores size less than 10 nm and a Nafion layer, wherein the Nafion layer is situated on top of said solid support In another embodiment, the Nafion layer is a colloidal Nafion solution which is deposited on said solid support.

In one embodiment, the filtration system of this invention comprises a solid support. In another embodiment, the solid support is a microfiltration filter. In another embodiment, the microfiltration filter comprises cellulose acetate (CA). In another embodiment, the microfiltration filter comprises polyether sulfone (PES). In another embodiment, the microfiltration filter comprises Teflon (PTFE). In another embodiment, the microfiltration filter comprises polycarbonate. In another embodiment, the microfiltration filter is commercially available having a pore size smaller or equal to 0.45 microns and larger than 5 nm. In another embodiment, the microfiltration filter has a pore size which is larger than 5 nm. In another embodiment, the microfiltration filter has a pore size smaller or equal to 0.45 microns. In another embodiment, the solid support is a microfiltration filter comprising cellulose acetate (CA), polyether sulfone (PES), teflon (PTFE), polycarbonate or combination thereof. In another embodiment, the solid support has pore size smaller than 10 nm.

In one embodiment, this invention is directed to a filtration system. In another embodiment, the filtration system comprises a solid support with pore size smaller than 10 nm and a Nafion layer. In another embodiment, the Nafion layer is situated on top of the solid support having a pore size smaller than 10 nm. In another embodiment, the Nafion layer is a colloidal solution of Nafion which is deposited on a solid support having a pore size smaller than 10 nm. In another embodiment, the Nafion layer is obtained by depositing colloidal solution of Nafion on a solid support. In another embodiment, the solid support has a pore size smaller than 10 nm.

In one embodiment, the filtration system, apparatus and methods of use thereof comprise and make use of a polymer layer. In another embodiment, the polymer comprises both hydrophilic and hydrophobic moieties.

In another embodiment, the polymer is Nafion. In another embodiment, the polymer is Nafion, polyacrylic acid sodium salt, alginic acid, poly(4-styrenesulfonic acid) or combination thereof. In one embodiment Nafion is sulfonated tetrafluoroethylene based fluoropolymer-copolymer. In another embodiment, the Nafion layer is prepared from a colloidal solution of Nafion. In another embodiment, the thickness of the Nafion layer in the filtration system is between 10 and 50 μm.

In one embodiment, the filtration system of this invention comprises PES as solid support, a PDI based membrane layer comprising 5% (mol %) of perylene diimide compound of formula II wherein “o” is 13 and 95% (mol %) of perylene diimide compound of formula II wherein “o” is 17, and Nafion as a polymer layer.

In one embodiment, the filtration system of this invention further comprises a reservoir for the filtration solution, which is connected to the filtration system. In another embodiment, the filtration system further comprises a pressure inducing element (e.g., piston or a pump), to facilitate filtration under pressure.

In one embodiment, this invention is directed to a filtration apparatus comprising:
a filtration system comprising a solid support, a membrane layer comprising perylene diimide (PDI) compound of this invention, and a polymer layer; wherein the PDI based membrane layer is located between the solid support and the polymer layer;
a first reservoir for filtration solution;
a first reservoir inlet (filtration inlet);
a first reservoir outlet;
a second reservoir for washing solution;
a second reservoir inlet (washing inlet);
a second reservoir outlet;
a connection between said second reservoir outlet and said first reservoir inlet, wherein said connection has an open or a closed position;
a pressure inducing element, said element is connected to a selector, adapted to connect the pressure inducing element with said first reservoir inlet, or with said washing inlet, or to disconnect said pressure element from said reservoirs;
an outlet from said filtration system;
   wherein,

at a first apparatus configuration, adapted for filtration, said first reservoir outlet is connected to said filtration system and said connection between said first reservoir inlet and second reservoir outlet is closed;

at a second apparatus configuration, adapted for washing, said first reservoir outlet is attached to said filtration system and said connection between said first reservoir inlet and second reservoir outlet is open such that said washing solution can be transferred from said second reservoir to said first reservoir;

and wherein said selector connects the pressure inducing element with said first reservoir inlet at said first configuration, and said selector connects the pressure inducing element with said second reservoir inlet at said second apparatus configuration.

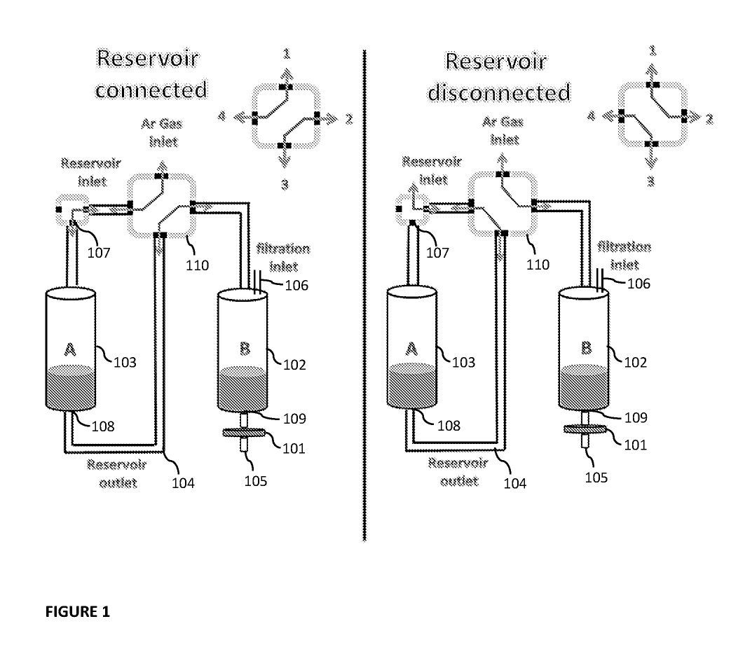

In one embodiment, the apparatus of this invention is as presented in FIG. 1. In another embodiment, the apparatus of this invention includes two configurations: a first configuration is adapted for filtration (right side of FIG. 1) and a second configuration is adapted for washing (left side of FIG. 1). Upon filtration (right side of FIG. 1), a filtration solution (an aqueous solution) is provided to the first reservoir for filtration (102) via the filtration inlet (106) and pressure is applied via a pressure inducing element (e.g., pressure of Ar gas, a piston, or a pump) which is connected to said first reservoir (102) through a selector (110). Upon application of pressure, the filtration solution is transferred via the first reservoir outlet (109) through the filtration system (101). The retentate maintains on the filtration system and the filtrate goes through the filtration outlet (105). During the filtration process, the second reservoir for washing (103) is disconnected by the selector (110) from the first reservoir for filtration (102). After the filtration step, a second apparatus configuration (left side of FIG. 1) is adapted by the selector (110) and the filtration system is washed with an aqueous solution or water from the second reservoir for washing (103), which is transferred from the second reservoir outlet (108) to the first reservoir (102) via connection line (104). In this second configuration of the apparatus, the connection between the two reservoirs (102 and 103) is open such that said washing solution is transferred from said second reservoir (103) to said first reservoir (102). The washing solution is transferred to the first reservoir (102) and further via the filtration system (101) upon application of pressure. The pressure inducing element is connected through the selector (110) to the second reservoir during the washing step. A washing solution is added to the second reservoir (103) via the second reservoir inlet (107).

In one embodiment, this invention is directed to a method of separation or filtration of materials, or purification of aqueous solutions comprising said materials, comprising transferring an aqueous solution or emulsion of the materials through the filtration system of this invention, wherein the filtration system comprises a solid support, a perylene diimide based membrane layer and a polymer layer wherein the perylene diimide based membrane is situated between the solid support and the polymer layer. In another embodiment, the separation or filtration of the materials, or purification of aqueous solutions comprising the materials is conducted at ambient pressure. In another embodiment, the separation or filtration of the materials, or purification of aqueous solutions comprising the materials is conducted under pressure. In another embodiment, the particles which are larger than the pores of said filtration system remain within the polymer layer or within the perylene diimide based membrane layer of the filtration system.

In another embodiment, the aqueous solution or emulsion comprising materials which are filtered through the filtration system or apparatus is contaminated water. In another embodiment, the contaminated water is wastewater, industrial effluents, or municipal or domestic effluents. In another embodiment, the contaminated water comprises chemical intermediates, chemical contaminants, biological contaminants or combination thereof. In another embodiment, the contaminants are agrochemicals, herbicides, pharmaceuticals and/or derivatives thereof. In another embodiment, the contaminated water comprises a chemical contaminant, a biological contaminant, a wastewater, a hydrocarbon, an agrochemical, an herbicide, a pharmaceutical, an industrial effluent, a municipal or domestic effluent, sulfur containing effluents, a metal or any combination thereof.

In another embodiment, the materials which are filtered through the filtration system or apparatus is water or brackish water using the methods of filtration of this invention for softening the water. In another embodiment, this invention provides a method of softening water, comprising transferring water or brackish water through the filtration system of this invention under pressure, wherein the alkali and alkaline salts which are larger than the pores of said filtration system remain within the polymer layer or within the perylene diimide based membrane layer.

In another embodiment, the materials to be filtered, or separated according to the methods of this invention comprise nanoparticles, heavy metal ions, salts, dyes, small organic molecules, pharmaceuticals or combination thereof. In another embodiment, the materials to be filtered are heavy metal ions, or mixtures thereof. Examples of heavy metal ions include but not limited to: Hg, Pb, Cd, Co, Ni, Cr, Zn, As ions and the like. In another embodiment, the metal is Hg ion. In another embodiment, the metal is Pb ion. In another embodiment, the metal is Cd ion. In another embodiment, the metal is Co ion. In another embodiment, the metal is Ni ion. In another embodiment, the metal is Cr ion. In another embodiment, the metal is Zn ion. In another embodiment, the metal is As ion. In another embodiment, the metal is any combination of Hg, Pb, Cd, Co, Ni, Cr, Zn and As ions.

In another embodiment, the aqueous solutions to be purified according to the methods of this invention comprise materials selected from: nanoparticles, heavy metal ions, salts, dyes, small organic molecules, pharmaceuticals or any combination thereof. In another embodiment, the materials are heavy metal ions or mixtures thereof. In another embodiment, the metal is Hg ion. In another embodiment, the metal is Pb ion. In another embodiment, the metal is Cd ion. In another embodiment, the metal is Co ion. In another embodiment, the metal is Ni ion. In another embodiment, the metal is Cr ion. In another embodiment, the metal is Zn ion. In another embodiment, the metal is As ion. In another embodiment, the metal is any combination of Hg, Pb, Cd, Co, Ni, Cr, Zn and As ions.

In one embodiment, the filtration step is conducted under pressure. In another embodiment the pressure is between 1-10 Atm. In another embodiment, the pressure is 3 Atm. In another embodiment the pressure is between 3 to 8 Atm. In another embodiment the pressure is between 3 to 7 Atm.

In one embodiment, this invention is directed to a method of separation or filtration of materials, or purification of aqueous solutions comprising said materials, comprising the steps of:
transferring an aqueous solution or emulsion of said materials through a first reservoir inlet of a filtration apparatus,
wherein said apparatus comprises:
   a filtration system comprising a solid support, a perylene diimide (PDI) based membrane layer comprising perylene diimide (PDI) compound of this invention and a polymer layer; wherein the PDI based membrane layer is located between the solid support and the polymer layer;
   a first reservoir for filtration solution;
   a first reservoir inlet (filtration inlet);
   a first reservoir outlet;
   a second reservoir for washing solution;
   a second reservoir inlet (washing inlet);
   a second reservoir outlet;
   a connection between said second reservoir outlet and said first reservoir, wherein said connection has an open or a closed position;
   a pressure inducing element, said element is connected to a selector, adapted to connect the pressure inducing element with said first reservoir, or with said washing inlet, or to disconnect said pressure element from said reservoirs; and
   an outlet from said filtration system;
   wherein,
   at a first apparatus configuration, adapted for filtration, said first reservoir outlet is connected to said filtration system and said connection between said first reservoir inlet and second reservoir outlet is closed;
   at a second apparatus configuration, adapted for washing, said first reservoir outlet is connected to said filtration system and said connection between said first reservoir inlet and second reservoir outlet is open such that said washing solution can be transferred from said second reservoir to said first reservoir;
   and wherein said selector connects the pressure inducing element with said first reservoir inlet at said first configuration, and said selector connects the pressure inducing element with said second reservoir inlet at said second apparatus configuration;
adapting a first apparatus configuration for filtration,
applying pressure such that said aqueous solution or emulsion is filtered via the filtration system and particles which are larger than the pores of said filtration system remain within said polymer layer or within said perylene diimide based membrane layer; and
adapting a second apparatus configuration for washing,
applying pressure such that the washing solution is transferred via the filtration system.

In one embodiment, the materials to be filtered, or separated using the filtration system, methods of separation or filtration of materials, methods of purification of aqueous solutions comprising said materials, or filtration apparatus of this invention comprise nanoparticles, heavy metal ions, salts, dyes, small organic molecules, pharmaceuticals or combination thereof. In another embodiment, the materials are heavy metal ions or mixtures thereof. In another embodiment, the metal is one or more selected from: Hg, Pb, Cd, Co, Ni, Cr, Zn and As ions. In another embodiment, the metal is Hg ion. In another embodiment, the metal is Pb ion. In another embodiment, the metal is Cd ion. In another embodiment, the metal is Co ion. In another embodiment, the metal is Ni ion. In another embodiment, the metal is Cr ion. In another embodiment, the metal is Zn. In another embodiment, the metal is As ion.

In one embodiment, the methods of this invention comprise transferring a filtration solution via the filtration system under pressure on the filtration solution. In another embodiment, following the transferring step (i.e. the filtration step), the filtration system is washed with water or an aqueous solution. In another embodiment, once the filtration system is washed, it can be reused.

In one embodiment, the perylene diimide based membrane layer according to this invention is recycled. In another embodiment, the recycling of the perylene diimide based membrane comprises (a) washing said filtration system and the retentate deposited thereon, with a solution of alcohol and water; (b) extracting said perylene diimide from said solution with an organic solvent; and (c) isolating said perylene diimide from said organic solvent. In another embodiment, the isolated perylene diimide can be further used to form a PDI membrane in aqueous conditions.

Applications in separation, filtration, and optimization of nanoparticles in a size domain is highly relevant to optical, catalytic, and biological applications. In one embodiment, nanoparticles refer to gold nanoparticles, metal nanoparticles, metal oxide nanoparticles, nanoparticles which are soluble in water, quantum dots (CdS nanoparticles, CdSe nanoparticles, CdTe nanoparticles), polymers, biomacromolecules, such as peptides, DNA, RNA, viruses, and proteins.

In one embodiment, this invention provides a method for separation, filtration, or optimization of biomolecules. In another embodiment, this invention provides a method for purification of aqueous solutions comprising biomolecules. In another embodiment, this invention provides a method for separation, filtration, or optimization of nanoparticles in a size domain of sub 5 nm. In another embodiment, this invention provides a method for purification of aqueous solutions comprising nanoparticles in a size domain of sub 5 nm. In another embodiment, applications in separation, filtration, or optimization of biomolecules in a size domain is highly relevant for medical and biological systems. In another embodiment, the biomolecules refer to peptides, DNA, RNA, proteins and separation of viruses.

In one embodiment, this invention provides a method for separation, filtration or optimization of nanoparticles, biomolecules, small organic molecules, heavy metal ions, salts, dyes and pharmaceuticals. In another embodiment, this invention provides a method for purification of aqueous solutions comprising nanoparticles, biomolecules, small organic molecules, heavy metal ions, salts, dyes and pharmaceuticals.

In one embodiment, this invention is directed to a method of decontaminating an aqueous solution, comprising transferring the contaminated aqueous solution via the filtration system of this invention. In another embodiment, the contaminated aqueous solution comprises decontamination of chemical intermediates, chemical contaminants, dyes, biological contaminants, wastewater, industrial effluents, municipal or domestic effluents, agrochemicals, herbicides and/or pharmaceuticals and derivatives thereof.

In one embodiment, the methods of this invention provide separation between nanoparticles or separation between biomolecules at a size range of between 0.01 nm and 40 nm. In one embodiment, the methods of this invention provide separation between nanoparticles or separation between biomolecules at a size range of between 0.01 nm and 1 nm. In one embodiment, the methods of this invention provide separation between nanoparticles or separation between biomolecules at a size range of between 0.1 nm and 5. In one embodiment, the methods of this invention provide separation between nanoparticles or separation between biomolecules at a size range of between 0.1 nm and 1 nm.

In one embodiment, the methods of this invention fractionate nanoparticles or fractionate biomolecules between 5 and 40 nm. In another embodiment this invention is directed to fractionates nanoparticles or fractionate biomolecules between 3 and 10 nm. In another embodiment this invention is directed to fractionates nanoparticles or fractionate biomolecules between 1 and 5 nm. In another embodiment this invention is directed to fractionates nanoparticles or fractionate biomolecules between 5 and 10 nm. In another embodiment this invention is directed to fractionates nanoparticles or fractionate biomolecules between 7 and 10 nm.

In one embodiment, this invention provides a method for separation or filtration of materials, purification of aqueous solutions comprising said materials and/or optimization of nanoparticles or biomolecules in a size domain. In another embodiment, the separation or filtration of materials, or purification of aqueous solutions comprising said materials is based on the thickness of the membrane. In another embodiment particles with a cap off of 5 nm are separated on a membrane of between 10-15 μm thickness. In another embodiment quantum dots of a size between 1-5 nm, are separated on a membrane of between 40-50 μm thickness. In another embodiment, this invention provides a chromatography medium for size-selective separation of nanoparticles or biomolecules.

In one embodiment the separated and/or fractionate nanoparticles do not aggregate or fuse using the methods of this invention.

In one embodiment the separated and/or fractionate biomolecules do not aggregate or fuse using the methods of this invention.

In one embodiment, the method of separation or filtration of biomolecules and/or purification of aqueous solutions comprising said biomolecules comprises transferring aqueous solution comprising biomolecules through the filtration system of this invention. In another embodiment, the transfer of biomolecules through the filtration system is done under pressure. In another embodiment, ultrafiltration is a pressure-driven separation process in which porous membranes retain particles larger than the membrane cut-off (ranging from 2 to 100 nm).

In one embodiment, the method of separation or filtration of chiral nano-materials and/or purification of aqueous solutions comprising said chiral nano-materials comprises transferring aqueous solution comprising nano-materials through the filtration system of this invention, wherein the PDI based membrane layer comprises one or more chiral perylene diimide compounds. In another embodiment, the transfer of aqueous solution comprising nano-materials through the chiral filtration system of this invention is done under pressure. In another embodiment, the chiral filtration system of this invention separates particles having different chirality.

In one embodiment, the PDI based membrane layer of the filtration system of this invention is readily prepared via one-step deposition of an aggregated perylene diimide of formula I-XVI solution on a microfiltration support. Owing to its noncovalent nature, the material is easily disassembled by organic solvent (e.g. ethanol), the retained particles are released, and the membrane material itself can be recycled and reused multiple times.

In one embodiment, this invention provides a method of recycling the noncovalent self-assembled perylene diimide based membrane layer comprising; (a) washing said microfiltration filter with the membrane of this invention and the retentate deposited thereon, with a solution of alcohol and water; (b) extracting said perylene diimide compound from said solution with an organic solvent; and (c) isolating said perylene diimide from said organic solvent. In another embodiment, the isolated perylene diimide can be further used to form a noncovalent self-assembled perylene diimide based membrane in aqueous conditions which can be further used as the PDI based membrane layer in the filtration system of this invention. In another embodiment the perylene diimide is isolated from said organic solvent by evaporation of the organic solvent. In another embodiment the perylene diimide is isolated from said organic solvent by precipitation of the perylene diimide from said organic solvent.

In one embodiment, a retentate is any material retained on the membrane of this invention during the separation, and/or purification process. In another embodiment the retentate refers to nanoparticles. In another embodiment, the retentate refers to biomolecules. In another embodiment, the retentate refers to chiral compounds. In another embodiment, the retentate refers to heavy metal ions. In another embodiment, the retentate refers to salts. In another embodiment, the retentate refers to pharmaceuticals. In another embodiment, the retentate refers to small organic molecules.

In another embodiment, the PDI based membrane layer is disassembled by organic solvent, cleaned, and can be reassembled, and reused in aqueous conditions, maintaining the same performance.

In one embodiment, this invention provides a method of isolating the retentate on the membrane of this invention comprising (a) washing said filtration system of this invention and said retentate deposited thereon with a solution of alcohol and water; (b) extraction of said perylene diimide structure from said solution with an organic solvent, and extracting said retentate from the remaining aqueous phase.

In another embodiment, the water:alcohol ratio in said solution is between about 5:5 to 3:7 v/v. In another embodiment, the water:alcohol ratio is about 4:6 v/v. In another embodiment, the alcohol is ethanol, methanol or isopropanol.

In one embodiment, this invention is directed to a method of preparing a filtration system of this invention, said method comprises:

(a) providing an organic solution of perylene diimide of this invention, wherein the organic solvent in said organic solution is miscible in water;

(b) adding excess of water to said solution of (a); wherein the organic solvent:water ratio is between about 1:99 to 8:92 v/v;

(c) evaporating said organic solvent;

(d) transferring the remaining aqueous solution or emulsion of (c) through a solid support; thereby obtaining PDI based membrane layer on said solid support; and

(e) depositing an aqueous solution or emulsion of a polymer on the PDI membrane layer;

thereby obtaining a filtration system of this invention comprising a solid support, a PDI based membrane layer and a polymer layer, wherein the PDI based membrane layer is located between the solid support and the polymer layer.

In one embodiment, the polymer layer is Nafion. In another embodiment the polymer solution of step (e) is a colloidal solution of Nafion. Using colloidal solution to prepare the Nafion layer is exceptional since the usual form of Nafion is a solid film. The solution processing opens up a new direction for Nafion deposition on various surfaces by the assistance of the PDI based membrane and is leading into enhanced filtration capabilities, especially regarding water purification (retention of heavy metal ions and small molecules).

In another embodiment, this invention is directed to a method of preparing a filtration system of this invention comprising dissolving perylene diimide of this invention in a mixture of an organic solvent miscible in water and water, wherein the organic solvent:water ratio is between about 10:90 to 3:97 v/v. In another embodiment the organic solvent:water ratio is about 5:95 v/v. In another embodiment the organic solvent:water ratio is about 3:97 v/v. In another embodiment the organic solvent:water ratio is about 2:98 v/v. In another embodiment the organic solvent:water ratio is about 1:99 v/v. In another embodiment the organic solvent:water ratio is about 1:99 to 8:92 v/v.

In another embodiment, the miscible organic solvent is THF, acetonitrile, acetone, methanol, ethanol, DMF, any other miscible organic solvent known in the art, or any combination thereof.

The term “about” or “approximately” as used herein means within an acceptable error range for the particular value as determined by one of ordinary skill in the art, which will depend in part on how the value is measured or determined, i.e., the limitations of the measurement system. For example, “about” can mean within 1 or more than 1 standard deviations, per the practice in the art. Alternatively, “about” can mean a range of up to 20%, and preferably up to 10% of a given value; such as within 7.5%, within 5%, within 2%, within 1%, within 0.5% of a given value.

The following examples are presented in order to more fully illustrate the preferred embodiments of the invention. They should in no way be construed, however, as limiting the broad scope of the invention.

### EXAMPLES

### Example 1

### Synthesis of PDI Compounds of this Invention

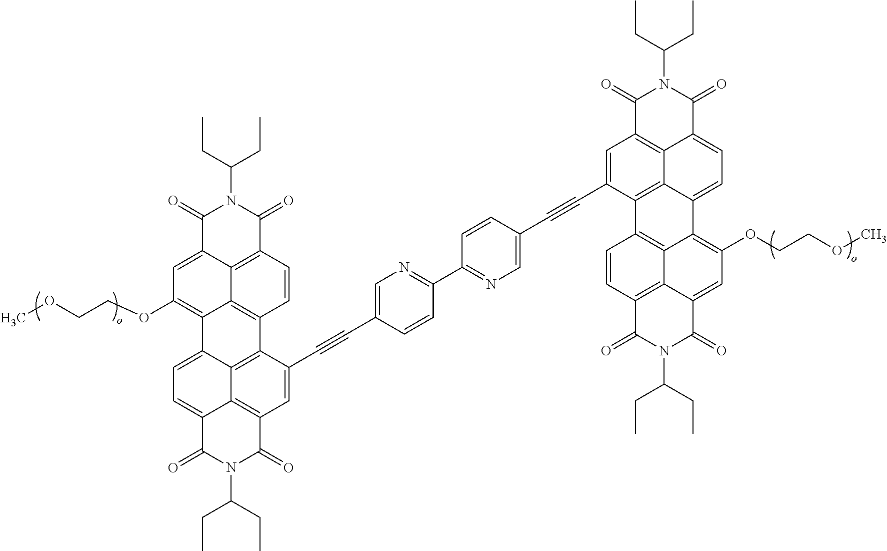

wherein o is between 1-100.

### 5,5′-Bis(1-PEG17-PDI-7-ethynyl)-2,2′-bipyridine (Compound II; o=17)

### Step 1

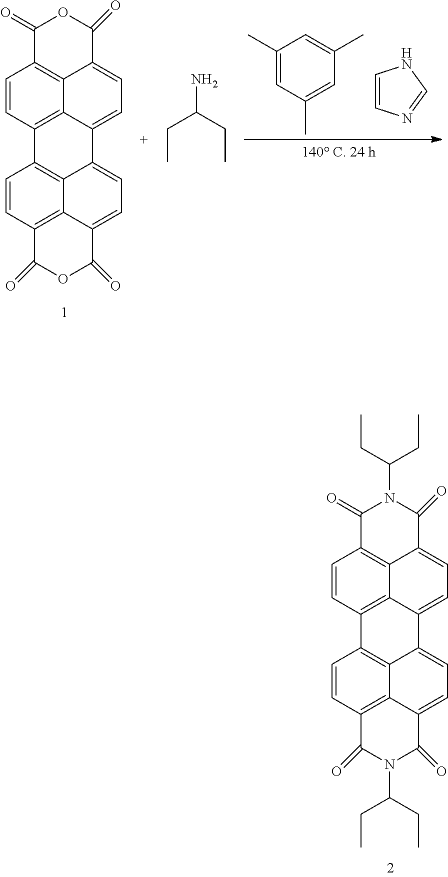

5 gr of perylene dianhydride (1), 18 gr imidazole, 4.5 mL ethylpropylamine (3-aminopentane) and 20 mL mesitylene (as additional solvent beside imidazole) were mixed and heated in oil bath to 140° C. deg for 24 h. 200 mL HCl 1M was added and stirred for 20 min. The solution was filtered and washed with EtOH. A red solid was obtained (2) and dried in high vacuum overnight. Yield: 76%.

### Step 2

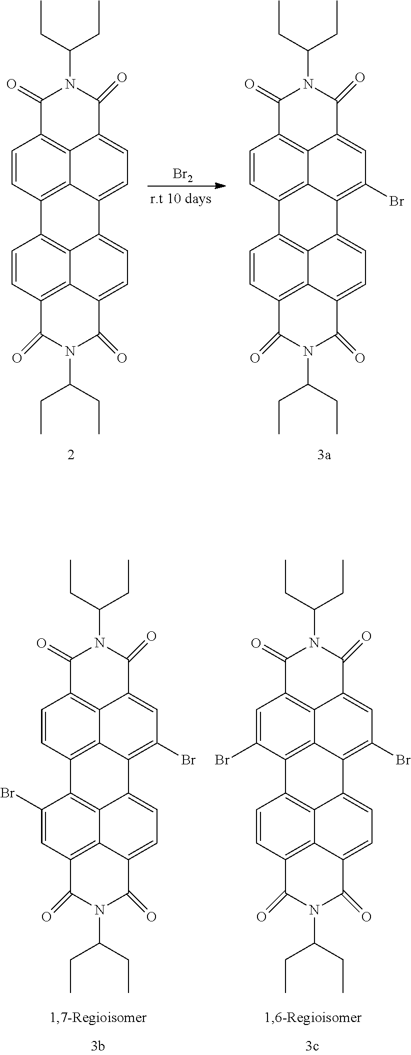

A mixture of 5.14 gr of perylene diimide (PDI 2), in 150 mL dichloromethane (DCM) was cooled to 00 deg in water bath and 27 mL bromine was added slowly using dropping funnel. The reaction mixture was stirred at room temperature for 10 days (slow reaction at room temp reduces the amount of undesired 1,6 regioisomer, 3c).

The bromine and DCM were evaporated with air bubbling using outlet to Na₂S₂O₃ saturated solution. The monobrominated Perylene diimide (3a) was purified using silica column with DCM as eluent.

### Step 3: Pegylated PDI

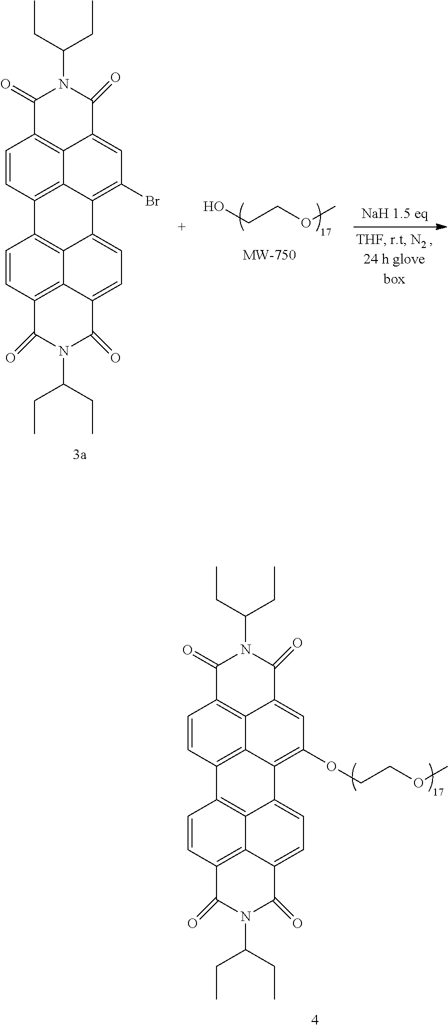

200 mg Br-PDI (3a) was dissolved in 30 mL of dry THF. 369 mg of dry PEG17-OH (˜750 MW) and 20 mg NaH were added to the reaction mixture. The color changed to purple. The reaction mixture was stirred for 24 h. The reaction is light sensitive, and should be conducted under dark.

The solvent was evaporated. The crude was dissolved in dichloromethane. Diluted HCl 1M solution was added and the layers were separated. The organic layer was collected, the solvent was evaporated and the product (4) was purified by column chromatography using silica and CHCl₃/MeOH as eluent mixture.

¹H NMR (CDCl₃, 300 MHz) of 4: δ=9.72 (d, 1H, J_{HH}=8.5 Hz, perylene-H), 8.62 (m, 5H, perylene-H), 8.45 (s, 1H, perylene-H), 5.06 (m, 2H, N(CH(CH₂CH₃)₂), 4.65 (m, 2H, PEG), 4.12 (m, 2H, PEG), 3.87-3.53 (m, 60H, PEG), 3.36 (s, 3H, PEG-OCH₃), 2.26 (m, 4H, N(CH(CH₂CH₃)₂), 1.94 (m, 4H, N(CH(CH₂CH₃)₂, 0.92 (t, 12H, J_{HH}=7.4 Hz, N(CH(CH₂CH₃)₂).

### Step 4: Monobromination of PEG-PDI

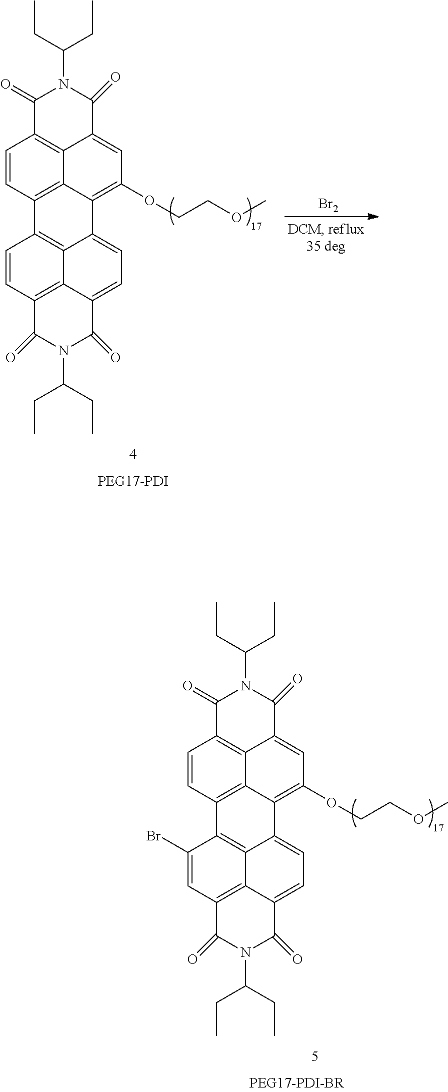

˜288 mg of PEG17-PDI (4) was dissolved in 100 mL of dichloromethane (DCM). 2.2 mL of Br₂ (cooled in ice) was added carefully. The reaction mixture was stirred under reflux (˜35 deg) while monitoring the reaction progress every 1 h using NMR. The reaction was conducted in the dark.

The bromine and DCM were evaporated with air bubbling using outlet to Na₂S₂O₃ saturated solution. The product was purified by column chromatography using silica and CHCl₃ or DCM as eluent. The product was dissolved in 10% MeOH/90% CHCl₃ and the PEG17-PDI-Br/PEG17-PDI mixture was filtered using PTFE filter and dried under high vacuum overnight. This mixture was used as-is in the following step.

### Step 5: 5,5′-Bis(1-PEG17-PDI-7-ethynyl)-2,2′-bipyridine (Compound VI)

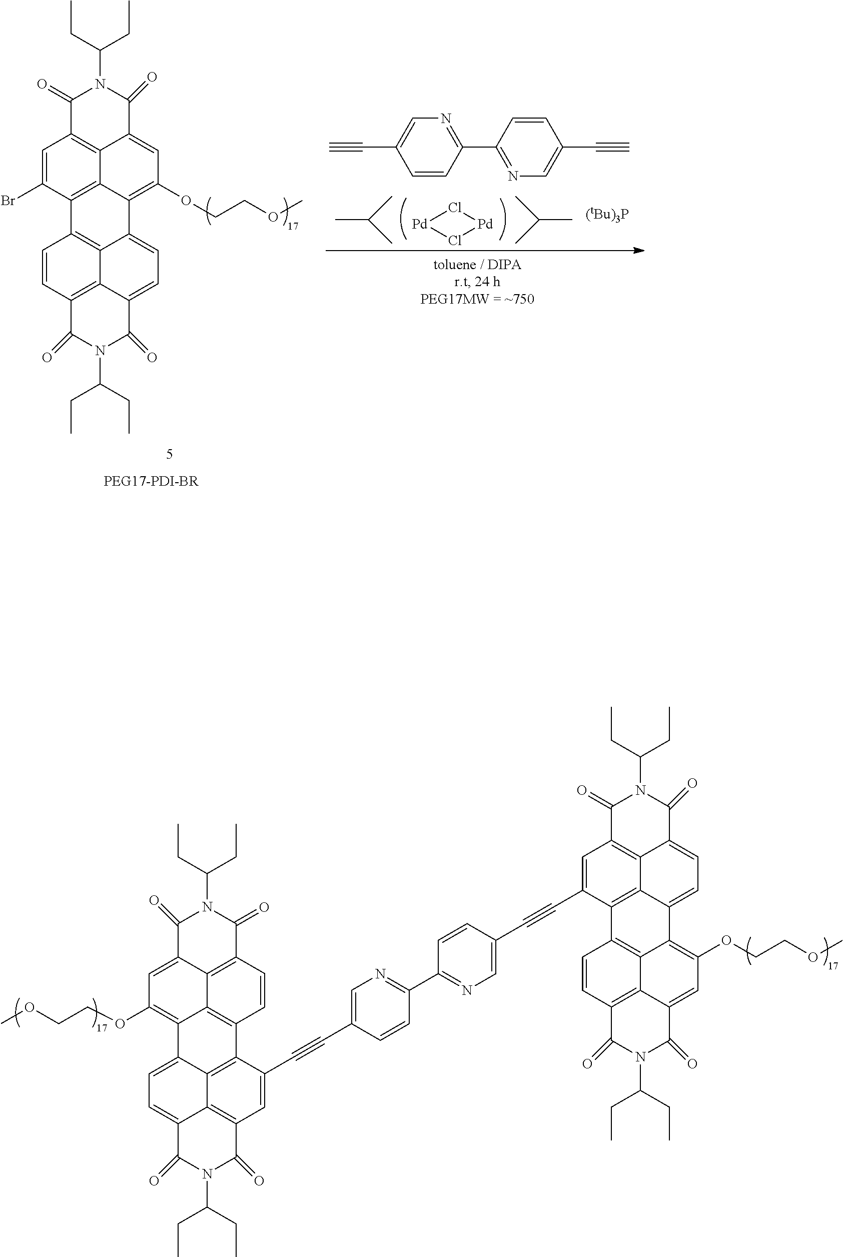

185 mg PEG-PDI-Br (calculated weight of PEG-PDI-Br in the mixture from previous step, based on NMR peak integration) was added to 3 mL dry toluene and the reaction mixture was stirred.

5.4 mg of methyl allyl palladium chloride dimer (catalyst) was added to a separate vial, mixed with 1 mL dry toluene and 55 mg/81 microliter P(tBu)₃ and stirred for 30 min.

The mixture in the vial was added to the PEG-PDI-Br reaction mixture and stirred for additional 30 min. 2 mL diisopropylamine (DIPA) was added and stirred for 30 min. 12.5 mg 5,5′-diethynyl-2,2′-bipyridine (as prepared in Example 11) was added and stirred at room temperature for 24 h. The reaction was conducted in the dark.

The solvents were evaporated and the crude was dried under high vacuum (to remove excess DIPA). The crude was washed with distilled H₂O and the organic phase was separated, dried with MgSO₄ and dried under high vacuum. The crude was washed with hexane following by ether. The residue was purified by column chromatography using silica, starting from acetone as an eluent, following by CHCl₃ and finally 10% MeOH/90% CHCl₃. Compound VI was isolated, filtered using PTFE filter and dried under high vacuum overnight. The product was obtained in 57% yield.

¹H NMR (CDCl₃, 300 MHz): δ=10.08 (d, 2H, J_{HH}=8.2 Hz, perylene-H), 9.73 (d, 2H, J_{HH}=8.4 Hz, perylene-H), 8.97 (s, 2H, bipy-H), 8.93 (s, 2H, perylene-H), 8.68 (dd, 4H, J_{HH}=8.3 Hz, 4.0 Hz, perylene-H, bpy-H), 8.62 (d, 2H, J_{HH}=8.2 Hz, perylene-H), 8.51 (s, 2H, perylene-H), 8.09 (d, 2H, J_{HH}=8.2 Hz, bpy-H), 5.08 (m, 4H, N(CH(CH₂CH₃)₂), 4.68 (m, 4H, PEG), 4.12 (m, 4H, PEG), 3.52-3.87 (m, 120H, PEG), 3.37 (s, 6H, PEG-OCH₃), 2.28 (m, 8H, N(CH(CH₂CH₃)₂), 1.96 (m, 8H, N(CH(CH₂CH₃)₂), 0.94 (m, 24H, N(CH(CH₂CH₃)₂).

MALDI-TOF-MS m/z calc. for C₁₅₂H₂₀₄N₆O₄₄: 2818.4, found: 2817.2 [M].

Starting materials were also purified (for recycling) by column chromatography with silica, using aceton as an eluent.

### 5,5′-Bis(1-PEG13-PDI-7-ethynyl)-2,2′-bipyridine (Compound II; o=13)

5,5′-Bis(1-PEG13-PDI-7-ethynyl)-2,2′-bipyridine (Compound II; o=13) was prepared similarly to 5,5′-Bis(1-PEG17-PDI-7-ethynyl)-2,2′-bipyridine with the exception of using the corresponding OH-PEG13 [—O(CH₂CH₂O)₁₃CH₃].

¹H NMR (CDCl3, 400 MHz) of 5,5′-Bis(1-PEG13-PDI-7-ethynyl)-2,2′-bipyridine: δ=10.07 (d, 2H, J_{HH}=8.2 Hz, perylene-H), 9.74 (d, 2H, J_{HH}=8.5 Hz, perylene-H), 8.99 (s, 2H, bipy-H), 8.94 (s, 2H, perylene-H), 8.69 (m, 6H, perylene-H, bpy-H), 8.52 (s, 2H, perylene-H), 8.13 (d, 2H, J_{HH}=8.1 Hz, bpy-H), 5.11 (m, 4H, N(CH(CH₂CH₃)₂), 4.68 (m, 4H, PEG), 4.12 (m, 4H, PEG), 3.53-3.87 (m, 96H, PEG), 3.37 (s, 6H, PEG-OCH₃), 2.28 (m, 8H, N(CH(CH₂CH₃)₂), 1.96 (m, 8H, N(CH(CH₂CH₃)₂), 0.94 (m, 24H, N(CH(CH₂CH₃)₂).

MALDI-TOF-MS of 5,5′-Bis(1-PEG13-PDI-7-ethynyl)-2,2′-bipyridine m/z calc. for C₁₃₆H₁₇₂N₆O₃₆: 2466.2, found: 2446.3 [M].

### 5,5′-Bis(1-PEG23-PDI-7-ethynyl)-2,2′-bipyridine (Compound II; o=23)

5,5′-Bis(1-PEG23-PDI-7-ethynyl)-2,2′-bipyridine (Compound II; o=23) was prepared similarly to 5,5′-Bis(1-PEG17-PDI-7-ethynyl)-2,2′-bipyridine with the exception of using the corresponding OH-PEG23. [—O(CH₂CH₂O)₂₃CH₃].

¹H NMR (CDCl3, 400 MHz) of 5,5′-Bis(1-PEG23-PDI-7-ethynyl)-2,2′-bipyridine (Compound II; o=23): δ=10.07 (d, 2H, J_{HH}=8.3 Hz, perylene-H), 9.71 (d, 2H, J_{HH}=8.5 Hz, perylene-H), 8.96 (s, 2H, bipy-H), 8.92 (s, 2H, perylene-H), 8.67 (dd, 4H, J_{HH}=8.3 Hz, 3.9 Hz, perylene-H, bpy-H), 8.61 (d, 2H, J_{HH}=8.4 Hz, perylene-H), 8.49 (s, 2H, perylene-H), 8.08 (d, 2H, J_{HH}=9.0 Hz, bpy-H), 5.07 (m, 4H, N(CH(CH₂CH₃)₂), 4.66 (m, 4H, PEG), 4.11 (m, 4H, PEG), 3.52-3.87 (m, 176H, PEG), 3.36 (s, 6H, PEG-OCH₃), 2.26 (m, 8H, N(CH(CH₂CH₃)₂), 1.95 (m, 8H, N(CH(CH₂CH₃)₂), 0.94 (m, 24H, N(CH(CH₂CH₃)₂).

MALDI-TOF-MS of 5,5′-Bis(1-PEG23-PDI-7-ethynyl)-2,2′-bipyridine (Compound II; o=23): m/z calc. for C₁₇₆H₂₅₂N₆O₅₆: 3346.7, found: 3348.9 [M].

### 5,5′-Bis(1-PEG44-PDI-7-ethynyl)-2,2′-bipyridine (Compound II; o=44)

5,5′-Bis(1-PEG44-PDI-7-ethynyl)-2,2′-bipyridine (Compound II; o=44) was prepared similarly to 5,5′-Bis(1-PEG17-PDI-7-ethynyl)-2,2′-bipyridine with the exception of using the corresponding OH-PEG44. [—O(CH₂CH₂O)₄₄CH₃]

¹H NMR (CDCl₃, 400 MHz) of 5,5′-Bis(1-PEG44-PDI-7-ethynyl)-2,2′-bipyridine: δ=10.07 (d, 2H, J_{HH}=8.2 Hz, perylene-H), 9.73 (d, 2H, J_{HH}=8.5 Hz, perylene-H), 8.98 (s, 2H, bipy-H), 8.94 (s, 2H, perylene-H), 8.69 (dd, 4H, J_{HH}=8.2 Hz, 4.5 Hz, perylene-H, bpy-H), 8.63 (d, 2H, J_{HH}=8.4 Hz, perylene-H), 8.51 (s, 2H, perylene-H), 8.10 (d, 2H, J_{HH}=9.7 Hz, bpy-H), 5.09 (m, 4H, N(CH(CH₂CH₃)₂), 4.67 (m, 4H, PEG), 4.11 (m, 4H, PEG), 3.52-3.87 (m, 344H, PEG), 3.37 (s, 6H, PEG-OCH₃), 2.28 (m, 8H, N(CH(CH₂CH₃)₂), 1.95 (m, 8H, N(CH(CH₂CH₃)₂), 0.91 (m, 24H, N(CH(CH₂CH₃)₂).

MALDI-TOF-MS of 5,5′-Bis(1-PEG44-PDI-7-ethynyl)-2,2′-bipyridine: m/z calc. for C₂₆₀H₄₂₀N₆O₉₈: 5196.8, found: 5211.7 [M+Na⁺].

### Example 2

### Preparation of the Filtration System of this Invention

All the filter systems of this invention included 13 mm diameter PES (0.45 m) support, a membrane layer of perylene diimide mixture of 5% Compound II PEG 13 with 95% Compound II PEG 17 and a Nafion layer.

Step I: Preparation of the Membrane Layer

5% (% mol) of compound II, wherein o=13 (PEG13) was mixed with 95% (% mol) of Compound II, wherein o=17 (PEG17) in a water/THF (2% THF by volume, 10⁻⁴M of total perylene diimide). The mixture was deposited on 13 mm diameter PES (0.45 μm) support to form a membrane. The mixture was deposited under pressure of 2 bar, ˜0.25 mg PDI mixture was deposited on the PES support.

Step II: Deposition of the Nafion Layer

After the perylene diimide (PDI) deposition on the PES support, the membrane was rinsed with water and 0.5 mL of Nafion perfluorinated resin (10 wt. % in H₂O eq. wt 1100, 527106Aldrich) is deposited on top (50 mg Nafion/0.25 mg PDI mixture). Then the membrane was rinsed with water and the filtration experiment can start (pressure of 3 Atm using Argon i.e. 2 atmospheres above atmospheric pressure).

The filtration system further includes a reservoir (Reservoir A in FIG. 1) to include the filtration solution which allows applying higher pressure to the filtration system (a pressure of between 3-8 Atm).

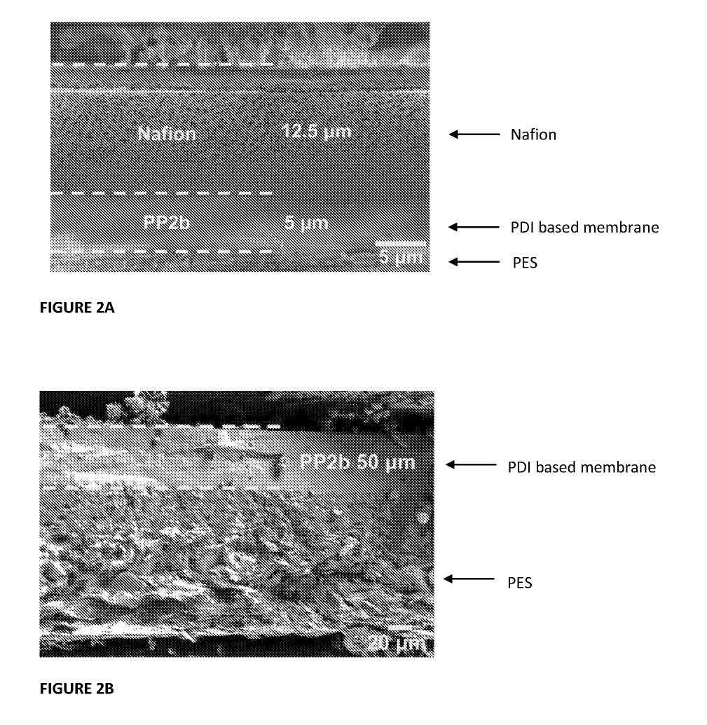

The fresh membranes of PDI layer [including a mixture of 5% (% mol) of compound II, wherein o=13 (PEG13) was mixed with 95% (% mol) of Compound II, wherein o=17 (PEG17)] were imaged using Cryo-SEM. The membrane cross-section (FIG. 2A) shows the sharp border between the PES support and the PDI layer (thickness of ˜5 μm), with the PDI layer being densified significantly from 50 μm (FIG. 2B) to about 5 m after deposition of the viscous Nafion solution (both membranes, with and without Nafion contain ˜0.25 mg PDI/filter). The top layers are composed of Nafion ion exchange polymer that can interact with charged species. From top to bottom view of the membranes a gradient of increased density is observed, hence the membrane becomes more and more dense until reaching the lower most PDI layer.

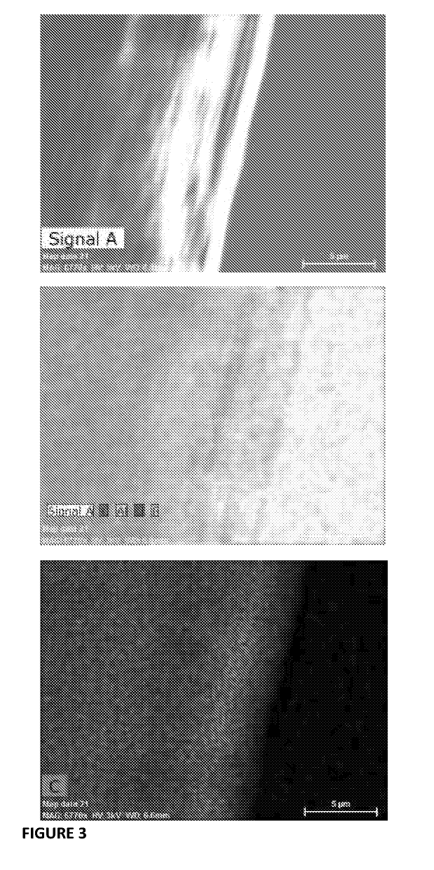

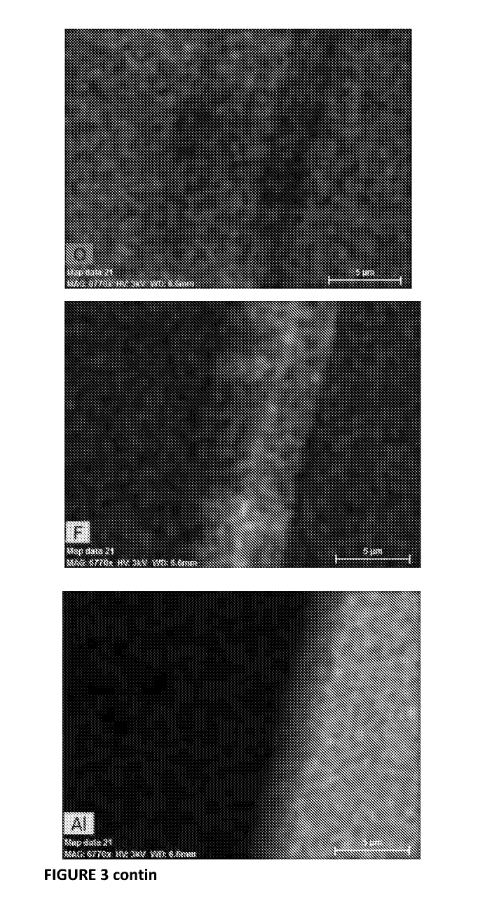

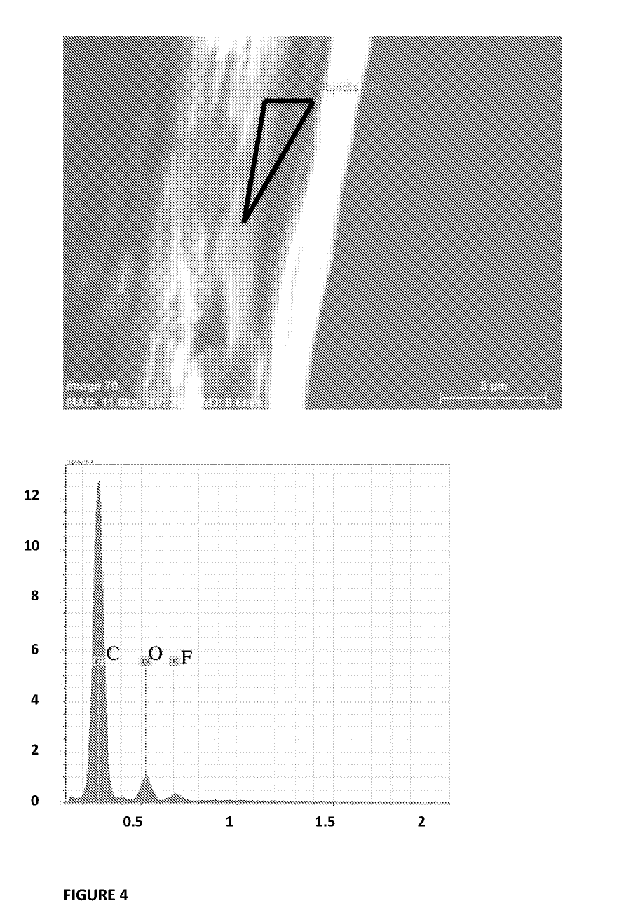

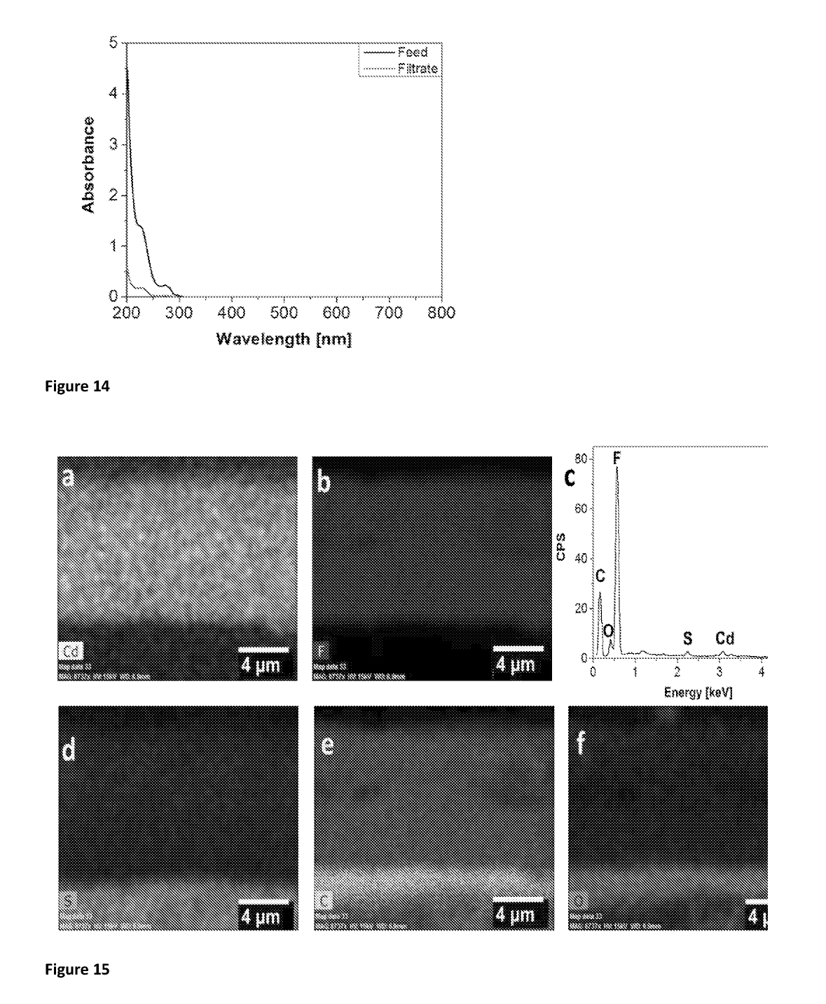

Another piece of the membrane was dried under high vacuum and its cross section was investigated using energy dispersive X-ray spectroscopy (EDS). The top layer is the Nafion (FIG. 3 in dark green) with a distinct separation from PDI. This layer is the only one containing the characteristic peak of F at ˜0.7 eV (FIG. 3, electron binding energy). Reducing the deposited Nafion quantity from 50 mg to 20 mg maintained the high efficiency for both heavy metal ions (Pb and Cd retention >99.5%, Table 4) and organic molecules (Amoxicillin, FIG. 14).

### Example 3

### Filtration Results Using the Filtration System of this Invention

### Filtration of Bromo Cresol Green

Bromo Cresol Green (BCG) has two forms an anionic form in neutral water and neutral form in acidic water. After filtration using the filtration system described in Example 2, both forms (anionic and neutral) are absent in the filtrate according to UV-vis spectroscopy. (FIG. 5)

The anionic BCG has an UV-vis absorption at 616 nm and the neutral BCG has an UV-vis absorption at 443 nm. The filtrate did not include these absorption signals concluding that both anionic and neutral BCG were caught by the filtration system.

### Filtration of Rhodamine 110

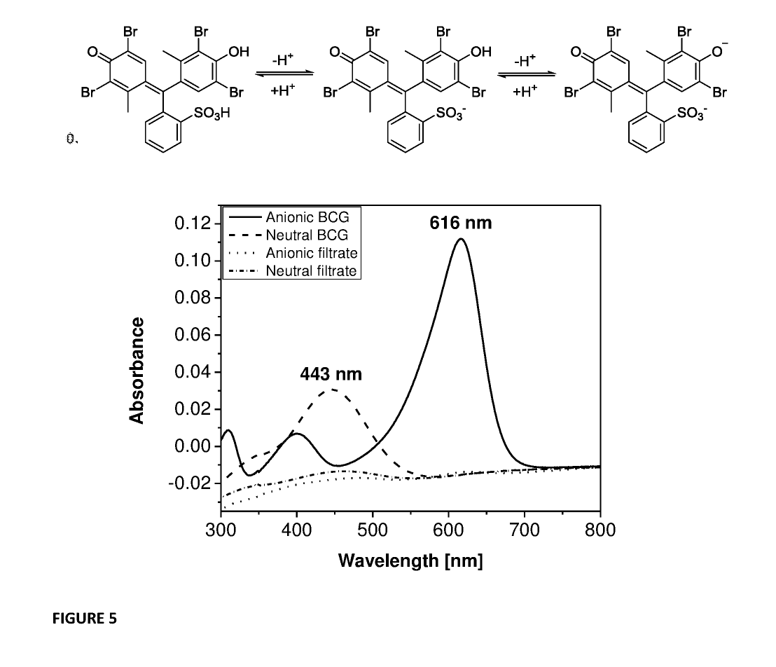

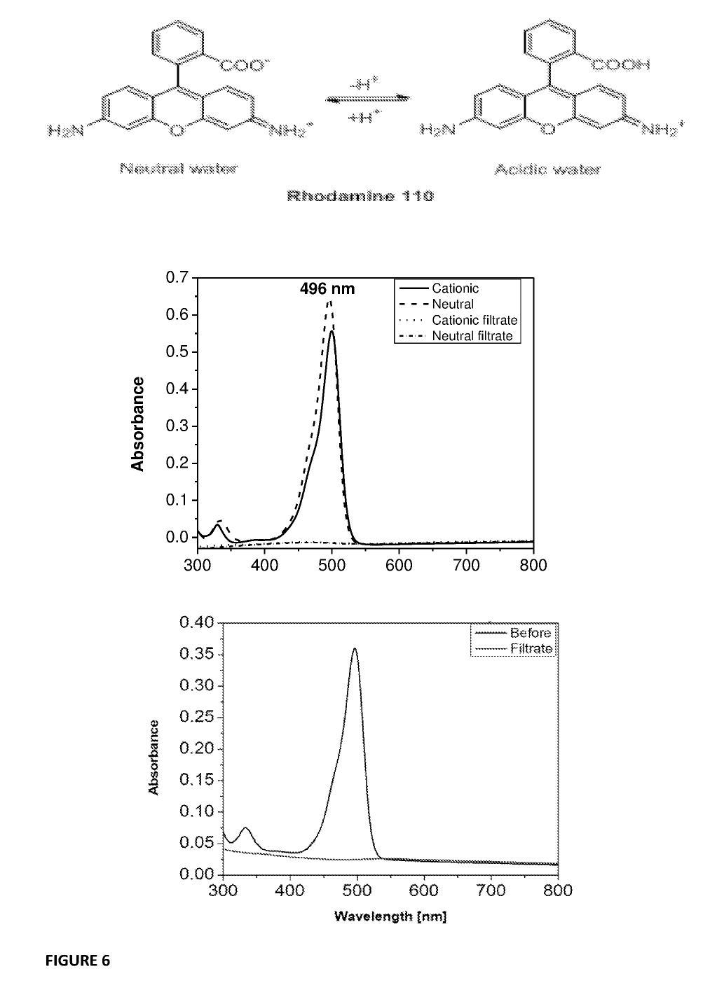

Rhodamine 110 from the Rhodamine family of dyes, is used as fluorophore in laser dyes and water flow direction/speed indicators. Rhodamine 110 was tested in its cationic and neutral forms. After filtration Rhodamine 110 in its cationic and neutral forms were absent in the filtrate according to UV-vis spectroscopy. (FIG. 6, top). Filtration of Rhodamine 110 at 5×10⁻⁴ M also demonstrate absence of the 496 nm peak characteristic of Rhodamine 110. (FIG. 6, bottom).

### Filtration of Small Molecules

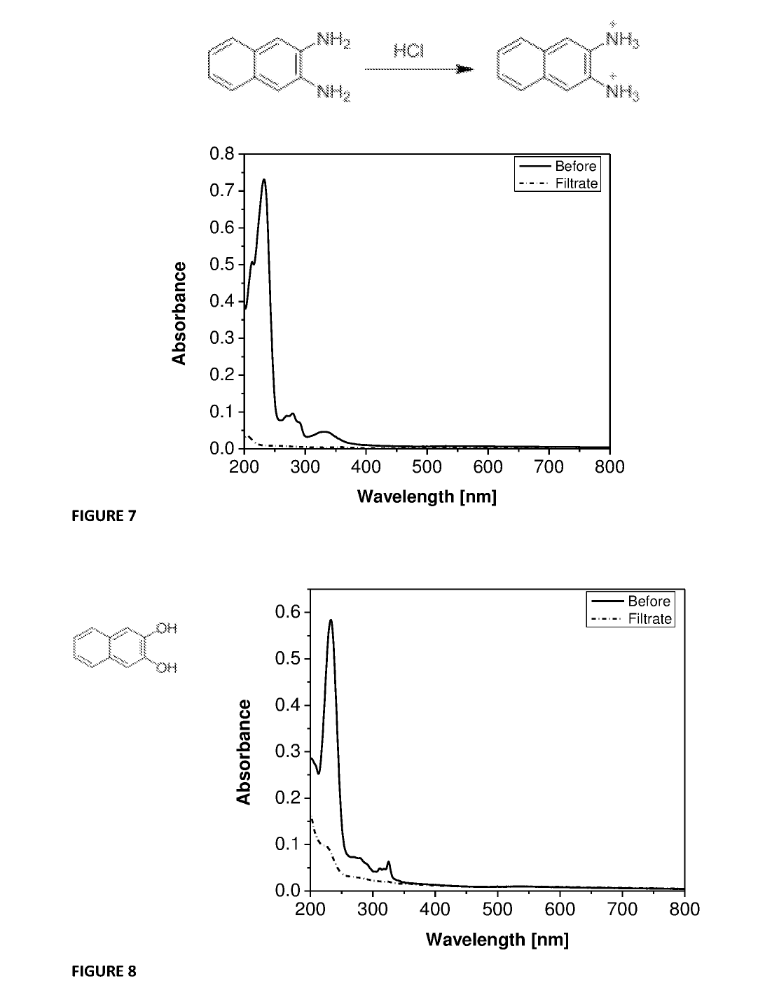

Filtration of two molecules with similar size, one positively charged (2,3-diaminonaphtalene 10⁻⁴M, dissolved with 1M HCl) (FIG. 7) and the other is neutral (2,3-dihydroxynaphtalene 10⁻⁴M)(FIG. 8). Both molecules were filtered using the filtration system of this invention (as described in Example 2, using 50 mg Nafion), but the charged amine groups seem to support the interaction with Nafion's Sulfonic acid binding sites and therefore enhance the molecule absorption according to UV-vis spectroscopy. Smaller molecules such as Trimethylphenyl ammonium chloride 5×10⁻⁴M were also filtered and are much more difficult to capture, although it is possible in some cases. Accordingly, it is suggested that the size of approximately a benzene ring as the borderline for filtration in case of small molecules so far.

### Filtration of Heavy Metal Ions

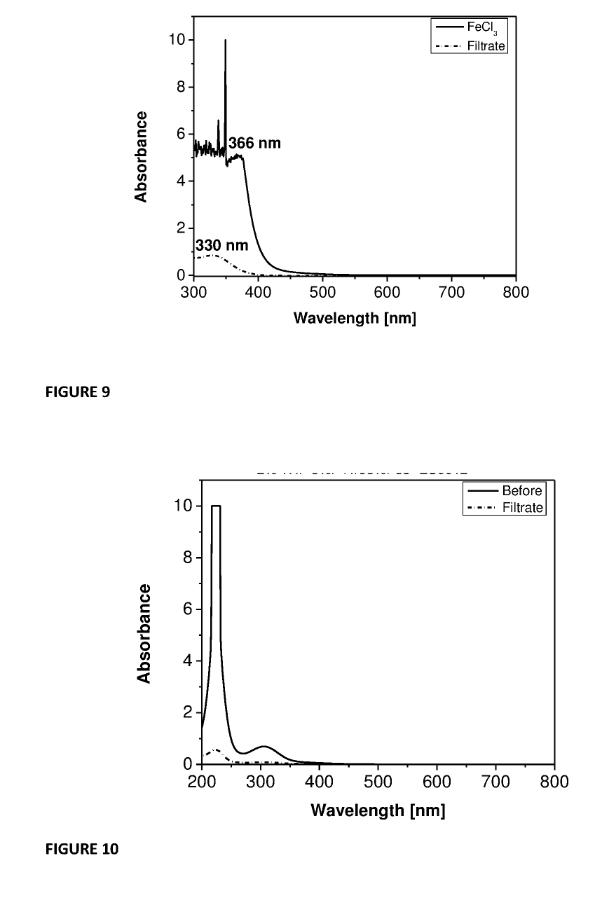

Very high loading (Absorption of ˜6 absorption units as can be seen in UV, this is a qualitative test) of ferric chloride FeCl₃ solution was transferred via the filter system of this invention (as described in Example 2, using 50 mg Nafion). FeCl₃ absorbs at 366 nm. After filtration (FIG. 9) most of the salt according to UV-vis spectroscopy was captured by the filter system of this invention. Since the Fe³⁺ ion is positively charged, negatively charged metal ion as in the case of chloroauric acid HAuCl₄ 10⁻³M was tested as well. After filtration (FIG. 10) high loading of a negatively charged metal was also captured using the filter system of this invention (Example 2).

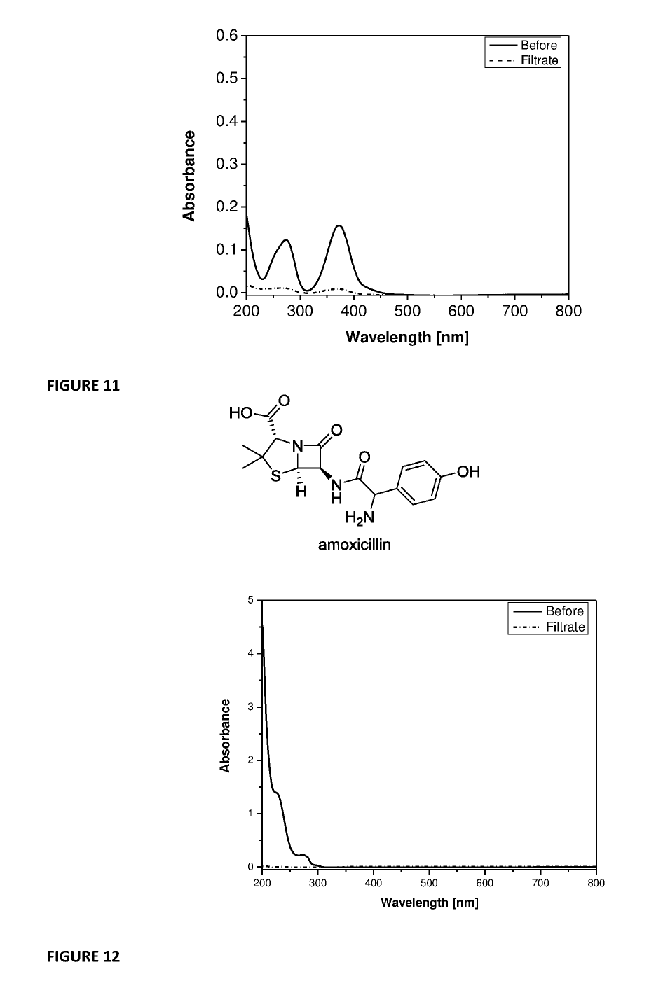

The filtration system of this invention can be used to purify contaminated water from toxic heavy metal ions, where hundreds of ppb is considered high concentration. Highly toxic and strong oxidizing agent of Cr⁶ present in Sodium dichromate dihydrate 10⁻⁴M, Na₂Cr₂O₇ was tested. After filtration Cr ions were almost absent in the filtrate according to UV-vis spectroscopy (FIG. 11). Other experiments with Lead, Nickel Cobalt and Cadmium both in extremely high concentration (see Table 1) to check its limit, and in lower concentration that is more typical for wastewater were performed.

The results were analyzed using Inductively Coupled Plasma MS (ICP-MS) before and after the filtration. Results of the high concentration are presented in Table 1.

TABLE 1
Filtration results of heavy metal ions in high concentrations
by 50 mg Nafion filtration system.

| | stock detected [ppb] | Filtrate [ppb] | |
|---|---|---|---|
| NiSO₄ | 518,134 | 4107 | (99.21% filtered) |
| CoCl₂ | 543,960 | 308 | (99.94% filtered) |
| Pb(NO₃)₂ | 636,959 | 4477 | (99.29% filtered) |
| CdSO₄ | 883,138 | 4857 | (99.45%) |

Ni and Co ions were removed in high efficiency of >99%

In lower concentration high removal efficiency for all the heavy metal ions were observed, indicating excellent properties in both regimes. These results presented in Table 2 are in agreement with the American EPA National primary drinking water regulations. http://water.epa.gov/drink/contaminants/uploaid/mcl-2.pdf.

TABLE 2
Filtration results of heavy metal ions in low concentrations
by 50 mg Nafion filtration system.

| | stock detected [ppb] | Filtrate [ppb] | |
|---|---|---|---|
| NiSO₄ | 1054 | 11 | (98.96% filtered) |
| CoCl₂ | 1031 | 0.18 | (99.98% filtered) |
| Pb(NO₃)₂ | 588 | 1-3 | (99.5% filtered) |
| CdSO₄ | 1075 | 0.20 | (99.98%) |

Moreover, a mixture containing a mixture of heavy metal ions (Pb, Cd, Co and Ni) was also retained (Table 3).

TABLE 3
Removal efficiencies of Ni²⁺, Co²⁺, Cd²⁺ and
Pb²⁺ mixture by 50 mg Nafion filtration system.

| | Initial metal | Filtrate metal | |
|---|---|---|---|
| | concentration | concentration | |
| Filtered salt | [ppb] | [ppb] (metal uptake %) | |
| NiSO₄•6H₂O | 1015 | 11.5 | (98.87%) |
| CoCl₂•6H₂O | 1075 | 0.5 | (99.95%) |
| Pb(NO₃)₂ | 2845 | 0.7 | (99.98%) |
| CdSO₄•8/3H₂O | 1151 | 0.03 | (99.99%) |

TABLE 4
Removal efficiencies of Pb²⁺ and Cd²⁺
by 20 mg Nafion filtration system..

| | Initial metal | Filtrate metal |
|---|---|---|
| | concentration | concentration |
| Filtered salt | [ppb] | [ppb] (metal uptake %) |
| Pb(NO₃)₂ | 168,503 | Not detected (99.99%) |
| CdSO₄ | 218,778 | 114 (99.95%) |

To test leaching of heavy metal ions contaminants retained in the membrane we filtered 5 mL of Pb in lower concentration (588 ppb) and collected 5 fractions of 1 mL each that were analyzed separately. Results showed that all fractions contain 1-3 ppb of Pb, demonstrating reliable metal retention.

### Filtration of Alkali and Alkaline Metal Ions

The filtration system of this invention (as described in Example 2) reduced the concentration of Na⁺, K⁺ and Mg²⁺ salts in water. Thus, the system of this invention can be used in softening and brackish water treatment into drinking water as presented in Table 5:

TABLE 5
Removal efficiencies of Na⁺, K⁺ and Mg²⁺ by 50 mg Nafion filtration system.

| | Standalone filtration | | Na + K + Mg mixture | |
|---|---|---|---|---|
| | Initial metal | Filtrate metal | Initial metal | Filtrate metal |
| | concentration | concentration | concentration | concentration |
| Filtered salt | [ppb] | [ppb] (metal uptake %) | [ppb] | [ppb] (metal uptake %) |
| NaCl | 675,958 | 90,917 (86.6%) | 503,490 | 285,856 (43.2%) |
| KCl | 254,924 | 34,896 (86.3%) | 495,953 | 168,913 (65.9%) |
| MgCl2 | 207,878 | 10,349 (95.1%) | 509,557 | 140,989 (72.3%) |

These results are promising for applications in water softening that usually contains high concentrations of magnesium and calcium ions that can cause severe corrosion in industrial plants equipment, blockage of pipelines and also damage domestic appliances.

### Filtration of a Mixture of Alkali/Alkaline Metal Ions and Heavy Metal Ions

The filtration system of this invention (as described in Example 2) demonstrated selectivity to heavy metal ions. A mixture of Cd ions in the presence of Na were applied to the filtration system and showed excellent retention of Cd (99.5%) in the presence of NaCl (21%), attesting to the selectivity towards heavy metal ions (Table 6). Thus, sodium, potassium, and magnesium salts are retained by the membrane to a much lesser extent than the heavy metal ions (Table 5).

TABLE 6
Removal efficiencies of Na⁺ and Cd²⁺ mixture
by 50 mg Nafion filtration system.

| | Initial metal | Filtrate metal | |
|---|---|---|---|
| | concentration | concentration | |
| Filtered salt | [ppb] | [ppb] (metal uptake %) | |
| NaCl | 865,763 | 681,942 | (21.2%) |
| CdSO₄ | 1104 | 5.1 | (99.5%) |

### Filtration of Pharmaceuticals

Amoxicillin is antibiotics, dissolved in water with 5 drops of NaOH 1M, 10⁻³M. After filtration using the filter system of this invention (Example 2) quantitative removal of Amoxicillin was observed according to UV-Vis spectroscopy. Such compounds can be found in the sewage system, primarily since drugs aren't fully adsorbed by the human body.

### Example 4

### Control Experiments of the Filtration System of this Invention

NADIR® PES +Nafion:

A control experiment, not including the PDI was performed. 0.5 mL of Nafion solution was deposited on 20 nm NADIR® PES support, the Nafion was washed with water and then filtration was performed. Small pore PES was used to check if Nafion can be deposited uniformly without PDI, assuming that small pore size enables deposition.

The following solutions were filtered:

K₃Fe(CN)₆ 10⁻³ M

Bromocresol Green

Sulforhodamine B 10⁻⁴M

All the compounds easily passed the PES/Nafion system and were not adsorbed onto the PES.

0.45 μm PES +Nafion:

A second control experiment, not including the PDI was performed. 0.5 mL of Nafion solution was deposited on 0.45 μm PES support, the Nafion was washed with water and then filtration was performed. Filtration of heavy metal ions in water (See Table 7) was performed. The filtration was not efficient compared with the filter system of this invention (Table 7). In addition, the Nafion was not uniform deposited on the PES and did not cover the support area well, allowing metal ions to pass (some of the ions were captured by Nafion on the support).

TABLE 7
Filtration of heavy metal ions via a control
system including PES and Nafion.

| | stock detected [ppb] | Filtrate [ppb] | |
|---|---|---|---|
| NiSO₄ | 518,134 | 315,838 | (~61% pass) |
| CoCl₂ | 543,960 | 439,555 | (~81% pass) |
| Pb(NO₃)₂ | 588 | 80 | (~14% pass) |

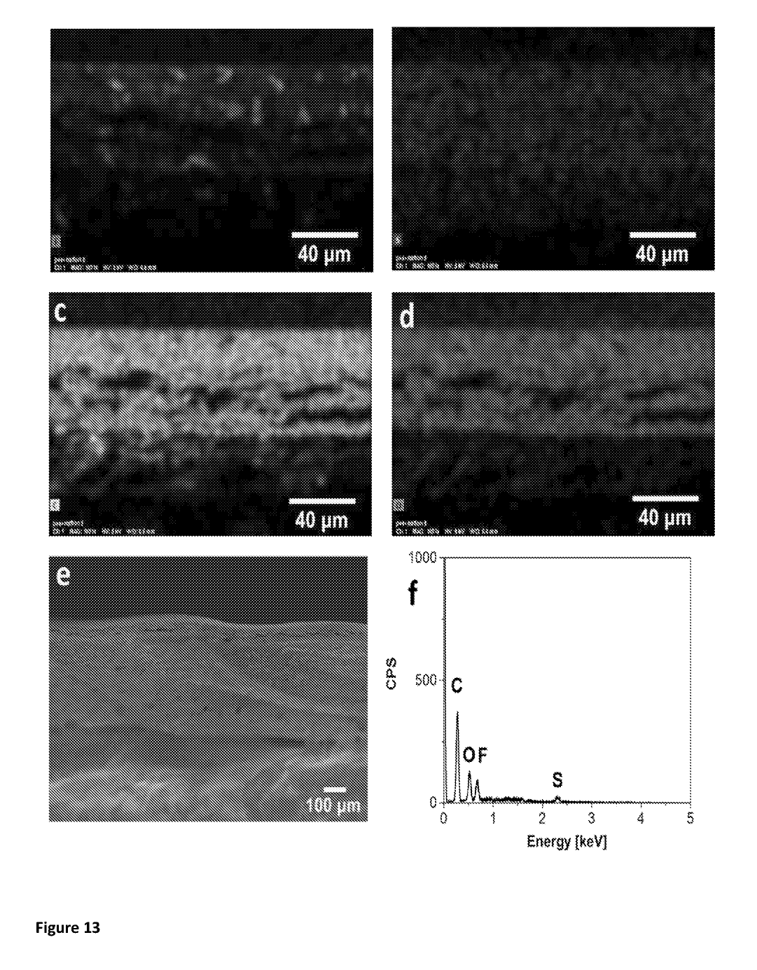

Thus, the control experiments showed low metal retentions, indicating the crucial role of a perylene diimide (PDI) based membrane layer. Thus, in the absence of a perylene diimide (PDI) based membrane layer the majority of Nafion passes through the membrane according to EDS (FIG. 13).

### Example 5

### Filtration System of this Invention Using Different Polymers

Filtration System of this Invention Comprising Polyacrylic Acid (PAA) Sodium Salt-MW 2 kDa

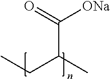

TABLE 8
Filtration via a filtration system including
solid support, PDI membrane and PAA

| | stock detected [ppb] | Filtrate [ppb] |
|---|---|---|
| NiSO₄ | 518,134 | 432,154 (17% filtered) |
| CoCl₂ | 543,960 | 382,313 (30% filtered) |

Deposition of the neat polymer PAA on a PDI based membrane layer of a mixture of 5% PDI of formula II wherein “o” is 13 (PEG13) and 95% PDI of formula II wherein “o” is 17 (PEG17); [10⁻⁴ M (2% THF)]; wherein the PDI based membrane is deposited on PES 0.45 microns—

was not achieved since it was water soluble, therefore it was crosslinked with CaCl₂ 1M such that the flow rate decreased from 0.04 to 0.01 mL/min (the flow rate of water through the PDI based membrane, first without PAA and then after PAA decreased). Washing the system with water led to dissolution of PAA and increased the flow rate to its original value of 0.04 mL/min Higher MW of PAA using a viscous solution of 5% wt PAA was deposited on the PDI based membrane/PES support as described above. The flow rate decreased from 0.2 to 0.004 mL/min and remained slow after washing with water. The removal of Co and Ni ions wasn't efficient as in the case of Nafion according to ICP-MS analysis.

Filtration System of this Invention Comprising Poly(4-Styrenesulfonic Acid)-PSS-MW 75 kDa-18% wt in Water

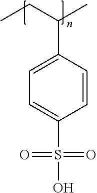

PSS (weight/concentration) was deposited on a PDI based membrane layer of a mixture of 5% PDI of formula II wherein “o” is 13 (PEG13) and 95% PDI of formula II wherein “o” is 17 (PEG17); [10⁻⁴ M (2% THF)]; wherein the PDI based membrane is deposited on PES 0.45 microns. This polymer was found to pass the PDI based membrane easily and after 5 min completely destroyed the PDI based membrane. The PSS is highly acidic and reactive.

Filtration System of this Invention Comprising Alginic Acid Sodium Salt-0.5% Wt in Water-Highly Viscous

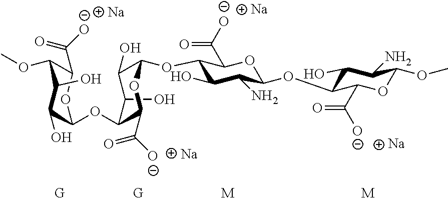

TABLE 9
Filtration via a filtration system including
solid support, PDI membrane and Alginate

| | stock detected [ppb] | Filtrate [ppb] |
|---|---|---|
| NiSO₄ | 518,134 | 29,486 (94% filtered) |
| CoCl₂ | 543,960 | 375,817 (31% filtered) |

Alginate (1 mL of 0.5% wt in water) was deposited on a PDI based membrane layer of a mixture of 5% PDI of formula II wherein “o” is 13 (PEG13) and 95% PDI of formula II wherein “o” is 17 (PEG17); [10⁻ M (2% THF)]; wherein the PDI based membrane is deposited on PES 0.45 microns.

Higher concentration of 2% wt was too viscous to flow through the membrane so it was decreased to 0.5% wt. The deposition of alginate on the PDI layer decreased the flow rate from 0.06 to 0.01 mL/min. The removal of Co and Ni ions wasn't efficient as in the case of Nafion according to ICP-MS analysis.

### Example 6

### Filtration Mechanism Study of the Filtration System of this Invention

A filtration mechanism study was performed to determine what are the retention sites using the filtration system of this invention. A filtration system as described in Example 2 (using 50 mg Nafion) was used for this study following filtration of CdSO₄. EDS measurements were done.

Results:

FIG. 15 shows clearly that Cd is located within the Nafion layer and not in perylene diimide or PES layers. Furthermore, the Cd distribution was uniform and higher concentration of Cd on top of Nafion was not observed. The performance presented herein is comparable or superior with commonly used membrane types such as ultrafiltration (UF), nanofiltration (NF) and reverse osmosis (RO) [Kurniawan, T. A.; Chan, G. Y. S.; Lo, W.-H.; Babel, S. Chem. Eng. J. 2006, 118, 83]. In case of Ni, for instance, metal retention is 60-100% using various UF, NF and RO membranes, with much lower initial metal concentration than the high concentration regime experiments presented herein [UF-Yurlova, L.; Kryvoruchko, A.; Kornilovich, B. Desalination 2002, 144, 255. Akita, S.; Castillo, L. P.; Nii, S.; Takahashi, K.; Takeuchi, H. J. Membr. Sci. 1999, 162, 111. Kryvoruchko, A.; Yurlova, L.; Kornilovich, B. Desalination 2002, 144, 243. NF-Wahab Mohammad, A.; Othaman, R.; Hilal, N. Desalination 2004, 168, 241. Ahn, K.-H.; Song, K.-G.; Cha, H.-Y.; Yeom, I.-T. Desalination 1999, 122, 77, and RO-Qin, J.-J.; Wai, M.-N.; Oo, M.-H.; Wong, F.-S. J. Membr. Sci. 2002, 208, 213].

In a similar fashion, Co retention is 95-100% [Akita, S.; Castillo, L. P.; Nii, S.; Takahashi, K.; Takeuchi, H. J. Membr. Sci. 1999, 162, 111. Kryvoruchko, A.; Yurlova, L.; Kornilovich, B. Desalination 2002, 144, 243]. Cd retention is 93-99% [Saffaj, N.; Loukili, H.; Younssi, S. A.; Albizane, A.; Bouhria, M.; Persin, M.; Larbot, A. Desalination 2004, 168, 301. Qdais, H. A.; Moussa, H. Desalination 2004, 164, 105].

However, the reported retentions can only be achieved at specific (optimum) pH values, whereas the filtration system of this invention doesn't require any pH adjustment. Furthermore, the filtration system of this invention demonstrated a significant performance advantage when compared with a commercial membrane comprised solely from Nafion (Nafion 117). In a study conducted on the adsorption of heavy metal ions by such membrane (Nafion), the following metal retentions were found: 96.2% (Ni²⁺), 90% (Co²⁺) and 88% (Pb²⁺) with an initial metal concentration of 1000 ppb [Nasef, M. M.; Yahaya, A. H. Desalination 2009, 249, 677] and the metal retentions dropped to as low as 56.7% (Pb²⁺) when the initial metal concentration is 200 ppb.

The filtration system of this invention demonstrated high retentions with high and low metal concentrations (Table 10).

TABLE 10
Removal efficiencies of Pb²⁺ (200 ppb
initial concentration) by the hybrid membrane.

| | Initial metal | Filtrate metal |
|---|---|---|
| | concentration | concentration |
| Filtered salt | [ppb] | [ppb] (metal uptake %) |
| Pb(NO₃)₂ | 197 | 1.4 (99.29%) |

Another advantage of the filtration system of this invention compared to known membranes is the irreversible fouling that leads to low flow rates. Cleaning the conventional covalent membranes is usually a difficult and expensive process, which is infeasible in some cases. In the case of the filtration system of this invention it can be deposited from solution on the standard filtration module (e.g. having large pore PES as a support membrane), disassembled upon fouling, cleaned, and reassembled again on the same module, emphasizing the advantage the hybrid supramolecular membrane of this invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A filtration system comprising a solid support, a perylene diimide based membrane layer and a polymer layer.

2. (canceled)

3. The filtration system of claim 1, wherein said peylene diimide based membrane layer is situated on said solid support and said polymer layer is situated on said perylene diimide based membrane layer.

4. The filtration system of claim 1, wherein said solid support is a microfiltration filter with pores smaller or equal to 0.45 microns.

5. The filtration system of claim 1, wherein said solid support is a microfiltration filter comprising cellulose acetate (CA), polyether sulfone (PES), teflon (PTFE), polycarbonate or combination thereof.

6. The filtration system of claim 1, wherein said perylene diimide based membrane layer comprises one or more self-assembled perylene diimide compounds, wherein each of said perylene diimide compounds is represented by the structure of formula I: 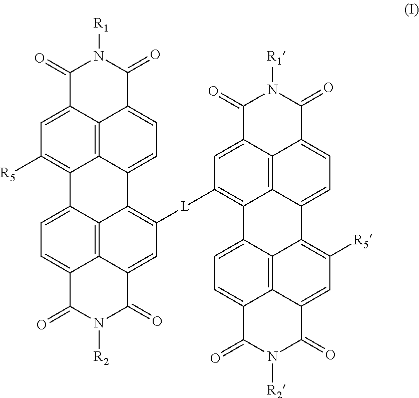
wherein
R₁ and R₁′ are each independently [(CH₂)_{q}O]ᵣCH₃, [(CH₂)_{q}O]ᵣH [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)_{q}NH]ᵣCH₃, [(alkylene)_{q}O]ᵣCH₃, [(alkylene)_{q}C(O)O]₁CH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₃NH]ₚH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₈)alkyl or (C₁-C₈)alkyl; and wherein R₃ in said [C(O)CHR₃NH]ₚH is an alkyl, haloalkyl, hydroxyalkyl, hydroxyl, aryl, phenyl, alkylphenyl, alkylamino and independently the same or different when p is larger than 1;
R₂ and R₂′ are each independently [(CH₂)_{q}O]ᵣCH₃, [(CH₂)_{q}C(O)O]ᵣCH₃, [(CH₂)_{q}C(O)NH]ᵣCH₃, [(CH₂)_{q}CH₂═CH₂]ᵣCH₃, [(CH₂)_{q}CH≡CH]ᵣCH₃, [(CH₂)NH]ᵣCH₃, [(alkylene)_{q}O]ᵣCH₃, [(alkylene)_{q}C(O)O]ᵣCH₃, [(alkylene)_{q}C(O)NH]ᵣCH₃, [(alkylene)_{q}CH₂═CH₂]ᵣCH₃, [(alkylene)_{q}CH≡CH]ᵣCH₃, [(alkylene)_{q}NH]ᵣCH₃, (C₁-C₃₂)alkyl, (C₃-C₈)cycloalkyl, aryl, heteroaryl, chiral group, (C₁-C₃₂)alkyl-COOH, (C₁-C₃₂)alkyl-Si-A, or [C(O)CHR₄NH]ₛH wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl); wherein A comprises three same or different of the following substituents Cl, Br, I, O(C₁-C₈)alkyl or (C₁-C₈)alkyl; and wherein R₄ in said [C(O)CHR₄NH]ₛH is an alkyl, haloalkyl, hydroxyalkyl, hydroxyl, aryl, phenyl, alkylphenyl, alkylamino and independently the same or different when s is larger than 1;
R₅ and R₅′ are each independently H, —ORₓ where Rₓ is C₁-C₆ alkyl, [(CH₂)ₙO]ₒCH₃ or [(CH₂)ₙO]ₒH; [(CH₂)ₙC(O)O]ₒCH₃, [(CH₂)ₙC(O)NH]ₒCH₃, [(CH₂)ₙCH₂═CH₂]ₒCH₃, [(CH₂)ₙCH≡CH]ₒCH₃, [(CH₂)ₙNH]ₒCH₃, [(alkylene)ₙO]ₒCH₃, [(alkylene)ₙC(O)O]ₒCH₃, [(alkylene)ₙC(O)NH]ₒCH₃, [(alkylene)ₙCH₂═CH₂]ₒCH₃, [(alkylene)ₙCH≡CH]ₒCH₃, [(alkylene)ₙNH]ₒCH₃, aryl, heteroaryl, C≡C—R₇, CH═CR₈R₉, NR₁₀R₁₁, chiral group, amino acid, peptide or a saturated carbocyclic or heterocyclic ring wherein said saturated heterocyclic ring or heteroaryl contains at least one nitrogen atom and R₅ or R₅′ are connected via the nitrogen atom and wherein said saturated carbocyclic ring, heterocyclic ring, aryl and heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);
R₇ is H, halo, (C₁-C₃₂)alkyl, aryl, NH₂, alkyl-amino, COOH, C(O)H, alkyl-COOH heteroaryl, Si(H)₃ or Si[(C₁-C₈)alkyl]₃ wherein said aryl or heteroaryl groups are optionally substituted by 1-3 groups comprising halide, aryl, heteroaryl, CN, CO₂H, OH, SH, NH₂, CO₂—(C₁-C₆ alkyl) or O—(C₁-C₆ alkyl);
R₈, R₉, R₁₀ and R₁₁ are each independently H, (C₁-C₃₂)alkyl, aryl, NH₂, alkyl-amino, COOH, C(O)H, alkyl-COOH or heteroaryl wherein said aryl or heteroaryl groups are optionally substituted by 1-3 groups comprising halide, CN, CO₂H, OH, SH, NH₂, CO₂—(C₁-C₆ alkyl) or O—(C₁-C₆ alkyl);
L is a linker;
n is an integer from 1-5;
o is an integer from 1-100;
p is an integer from 1-100;
q is an integer from 1-5;
r is an integer from 1-100; and
s is an integer from 1-100;
wherein if R₅ and/or R₅′ are chiral; said membrane will form a chiral membrane.

7. The filtration system of claim 1, wherein said perylene diimide based membrane layer comprises one or more perylene diimide compounds, wherein each of said perylene diimide compounds is represented by the structure of formula II: 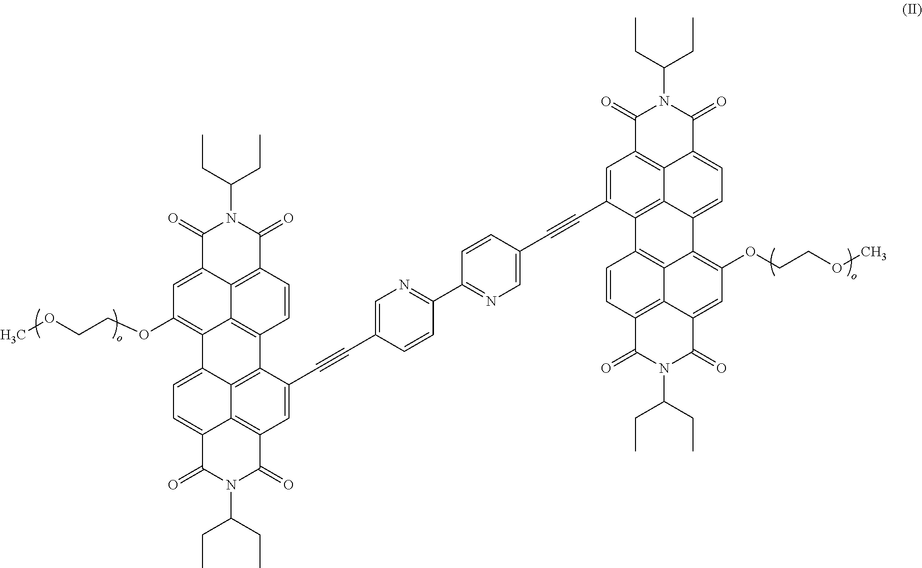
wherein o is an integer between 1 to 100.

8. The filtration system of claim 7, wherein said perylene diimide based membrane layer comprises self-assembled of 2 to 10 perylene diimide compounds of formula II, wherein each has a different integer “o”.

9. The filtration system of claim 8, wherein said perylene diimide based membrane layer comprises 5%4 (mol %) of perylene diimide compound of formula II wherein “o” is 13 and 95% (mol %) of perylene diimide compound of formula II wherein “o” is 17.

10. (canceled)

11. (canceled)

12. The filtration system of claim 1, wherein the solid support is PES.

13. The filtration system of claim 1, wherein said polymer layer is Nafion, polyacrylic acid sodium salt, alginic acid, poly(4-styrenesulfonic acid) or combination thereof.

14. (canceled)

15. The filtration system of claim 1, wherein said polymer layer comprises Nafion and said solid support comprises PES.

16. A method of separation or filtration of materials, or purification of aqueous solutions comprising said materials, comprising transferring an aqueous solution or emulsion of said materials through said filtration system according to claim 1 under pressure, wherein the particles which are larger than the pores of said filtration system remain within said polymer layer or within said perylene diimide based membrane layer.

17. A method of softening water, comprising transferring water or brackish water through said filtration system according to any one of claim 1 under pressure, wherein alkali and alkaline salts which are larger than the pores of said filtration system remain within said polymer layer or within said perylene diimide based membrane layer.

18. The method of claim 16, wherein said material comprises nanoparticles, heavy metal ions, salts, dyes, small organic molecules or pharmaceuticals.

19. The method of claim 16, wherein said pressure is between 3 to 10 Atm.

20. The method of claim 16, wherein following the transferring step, the filtration system is washed with a washing solution.

21. The method of claim 16, wherein said washing solution is water.

22. The method of claim 16, wherein said perylene diimide based membrane layer is further recycled.

23. The method of claim 22, wherein said recycling comprises; (a) washing said filtration system and the retentate deposited thereon, with a solution of alcohol and water; (b) extracting said perylene diimide from said solution with an organic solvent; and (c) isolating said perylene diimide from said organic solvent.

24. The method of claim 23, wherein said isolated perylene diimide can be further used to form a noncovalent self-assembled perylene diimide based membrane in aqueous conditions.

25. A filtration apparatus comprising:
a filtration system comprising a solid support, a perylene diimide (PDI) based membrane layer comprising perylene diimide (PDI) based compound and a polymer layer; wherein the PDI based membrane layer is located between the solid support and the polymer layer;
a first reservoir for filtration solution;
a first reservoir inlet (filtration inlet);
a first reservoir outlet;
a second reservoir for washing solution;
a second reservoir inlet (washing inlet);
a second reservoir outlet;
a connection between said second reservoir outlet and said first reservoir inlet, wherein said connection has an open or a closed position;
a pressure inducing element, said element is connected to a selector, adapted to connect the pressure inducing element with said first reservoir, or with said washing inlet, or to disconnect said pressure element from said reservoirs;
an outlet from said filtration system;
wherein,
at a first apparatus configuration, adapted for filtration, said first reservoir outlet is connected to said filtration system and said connection between said first reservoir inlet and second reservoir outlet is closed;
at a second apparatus configuration, adapted for washing, said first reservoir outlet is attached to said filtration system and said connection between said first reservoir inlet and second reservoir outlet is open such that said washing solution can be transferred from said second reservoir to said first reservoir;
and wherein said selector connects the pressure inducing element with said first reservoir inlet at said first configuration, and said selector connects the pressure inducing element with said second reservoir inlet at said second apparatus configuration.

26. (canceled)

27. (canceled)

28. (canceled)

29. (canceled)

30. (canceled)

31. (canceled)

32. (canceled)

33. (canceled)

34. (canceled)

35. (canceled)

36. A method of separation or filtration of materials, or purification of aqueous solutions comprising said materials, comprising the steps of:
transferring an aqueous solution or emulsion of said materials through a first reservoir inlet of a filtration apparatus, wherein said apparatus comprises:
a filtration system comprising a solid support, a perylene diimide (PDI) based membrane layer comprising perylene diimide (PDI) based compound and a polymer layer; wherein the PDI based membrane layer is located between the solid support and the polymer layer;
a first reservoir for filtration solution;
a first reservoir inlet (filtration inlet);
a first reservoir outlet;
a second reservoir for washing solution;
a second reservoir inlet (washing inlet);
a second reservoir outlet;
a connection between said second reservoir outlet and said first reservoir, wherein said connection has an open or a closed position;
a pressure inducing element, said element is connected to a selector, adapted to connect the pressure inducing element with said first reservoir, or with said washing inlet, or to disconnect said pressure element from said reservoirs;
an outlet from said filtration system;
wherein,
at a first apparatus configuration, adapted for filtration, said first reservoir outlet is connected to said filtration system and said connection between said first reservoir inlet and second reservoir outlet is closed;
at a second apparatus configuration, adapted for washing, said first reservoir outlet is connected to said filtration system and said connection between said first reservoir inlet and second reservoir outlet is open such that said washing solution can be transferred from said second reservoir to said first reservoir;
and wherein said selector connects the pressure inducing element with said first reservoir inlet at said first configuration, and said selector connects the pressure inducing element with said second reservoir inlet at said second apparatus configuration;
adapting a first apparatus configuration for filtration,
applying pressure such that said aqueous solution or emulsion is filtered via the filtration system and particles which are larger than the pores of said filtration system remain within said polymer layer or within said perylene diimide based membrane layer; and
adapting a second apparatus configuration for washing,
applying pressure such that the washing solution is transferred via the filtration system.

37. The method of claim 36, wherein said pressure is between 3 to 10 Atm.

38. The method of claim 36, wherein said material comprises nanoparticles, heavy metal ions, salts, dyes, small organic molecules, or pharmaceuticals.

39. The method of claim 36, wherein said washing solution is water.

40. The method of claim 36, wherein said perylene diimide based membrane layer is further recycled.

41. The method of claim 40, wherein said recycling comprises; (a) washing said filtration system and the retentate deposited thereon, with a solution of alcohol and water; (b) extracting said perylene diimide based compound from said solution with an organic solvent; and (c) isolating said perylene diimide based compound from said organic solvent.

42. The method of claim 41, wherein said isolated perylene diimide based compound can be further used to form a noncovalent self-assembled perylene diimide based membrane in aqueous conditions.

43. A filtration system comprising a solid support with pores size less than 10 nm and a Nafion layer, wherein said Nation layer is situated on top of said solid support.

44. The filtration system of claim 43, wherein said Nation layer is a colloidal Nation solution which is deposited on said solid support.
